(19) United States
(12) Patent Application Publication
(10) Pub. No.: US 2016/0294028 A1
(43) Pub. Date: Oct. 6, 2016

(54) SOLID STATE BATTERY CELLS AND METHODS FOR MAKING AND USING SAME

(71) Applicant: Yan Ye, Saratoga, CA (US)

(72) Inventor: Yan Ye, Saratoga, CA (US)

(21) Appl. No.: 15/079,539

(22) Filed: Mar. 24, 2016

Related U.S. Application Data
(60) Provisional application No. 62/142,696, filed on Apr. 3, 2015.
(60) Provisional application No. 62/219,854, filed on Sep. 17, 2015.
(60) Provisional application No. 62/287,571, filed on Jan. 27, 2016.

(51) Int. Cl. H01M 12/08; H01M 4/86; H01M 4/134; H01M 4/04; H01M 10/0562; H01M 10/054; H01M 8/1016; H01M 4/46; H01M 4/1395

(52) U.S. Cl. CPC H01M 12/08; H01M 4/466; H01M 4/8673; H01M 4/134; H01M 4/1395; H01M 4/8663; H01M 10/0562; H01M 10/054; H01M 8/1016; H01M 4/0492; H01M 2004/027

(57) ABSTRACT

Solid state battery cells and methods for making the same are provided. In one or more embodiments, a solid state battery cell can include one or more solid state ion conductors disposed between one or more electrodes and one or more counter electrodes. The electrode can include at least 90 at % of magnesium, the counter electrode can be or include one or more electrically conductive materials, and the solid state ion conductor can be or include one or more ion conductive materials. The ion conductive material can be or include one or more magnesium compounds and the counter electrode and the solid state ion conductor can have a combined thickness of about 1 μm to less than 1 mm.

### CROSS-REFERENCE TO RELATED APPLICATIONS

This application claims the benefit of U.S. Provisional Patent Application No. 62/142,696, filed on Apr. 3, 2015; U.S. Provisional Patent Application No. 62/219,854, filed on Sep. 17, 2015; and U.S. Provisional Patent Application No. 62/287,571, filed on Jan. 27, 2016, which are all incorporated by reference herein.

### BACKGROUND

1. Field

Embodiments described generally relate to solid state battery cells and methods for making and using same. More particularly, such embodiments relate to solid state battery cells containing magnesium and methods for making and using same.

2. Description of the Related Art

Conventional batteries can typically have a liquid electrolyte or a gel electrolyte. These liquid and gel electrolytes can be corrosive and can be harmful if exposed to a person or other living organism. Conventional batteries can also be bulky and have limited shapes and sizes dictated, in part, by the amount of electrolyte and the protective seal needed for containing the electrolyte therein.

Solid state battery cells can have electrodes that contain lithium or a coinage metal, such as copper, silver, or gold. Solid state batteries containing electrodes made from metallic lithium can be explosive during the manufacturing process, as well as during storage, shipping, and use. Solid state batteries containing electrodes made from a coinage metal can have a relatively low charge density and can be much more expensive to manufacture than other batteries with a similar charge density.

There is a need, therefore, for improved solid state battery cells and methods for making solid state battery cells. The solid state battery cells can have smaller sizes, greater open circuit voltages, and/or easier and less expensive to produce than traditional batteries that have a comparable power density.

### SUMMARY

Solid state battery cells and methods for making the same are provided. In one or more embodiments, a solid state battery cell can include one or more solid state ion conductors disposed between one or more electrodes and one or more counter electrodes. The electrode can include at least 90 atomic percent (at %) of magnesium, the counter electrode can be or include one or more electrically conductive materials, and the solid state ion conductor can be or include one or more ion conductive materials. The ion conductive material can be or include one or more magnesium compounds and the counter electrode and the solid state ion conductor can have a combined thickness of about 1 μm to less than 1 mm.

In some embodiments of the solid state battery cell, the electrode can include at least 90 at % of magnesium, the counter electrode can be or include one or more electrically conductive materials and one or more ion conductive substances, and the solid state ion conductor can be or include one or more ion conductive materials. The ion conductive material can be or include a hydrated material.

In other embodiments, a method for making a solid state battery cell can include combining one or more magnesium-containing substrates and one or more reagent solutions to produce a mixture. The magnesium-containing substrates can include at least 90 at % of magnesium. The method can also include reacting a portion of the magnesium-containing substrate and the reagent solution in the mixture to produce one or more solid state ion conductors disposed on an electrode. The solid state ion conductor can be or include one or more ion conductive materials derived from the reacted portion of the magnesium-containing substrate and the reagent solution. The electrode can include an unreacted portion of the magnesium-containing substrate. The method can further include forming one or more counter electrodes containing one or more electrically conductive materials on or over the solid state ion conductor. The solid state ion conductor can be disposed at least partially between the electrode and the counter electrode and the counter electrode and the solid state ion conductor can have a combined thickness of about 1 μm to less than 1 mm.

### BRIEF DESCRIPTION OF THE DRAWINGS

So that the manner in which the above recited features can be understood in detail, a more particular description, briefly summarized above, may be had by reference to embodiments, some of which are illustrated in the appended drawing. It is to be noted, however, that the appended drawing illustrate only typical embodiments and are therefore not to be considered limiting of its scope, for the invention may admit to other equally effective embodiments.

FIG. 1 depicts a perspective view of an illustrative solid state battery cell, according to one or more embodiments described.

FIG. 2 depicts a sectional view of the solid state battery cell along line 2-2 in FIG. 1.

FIG. 3 depicts a sectional view of the solid state battery cell along line 3-3 in FIG. 1.

FIG. 4 depicts a perspective view of another illustrative solid state battery cell, according to one or more embodiments described.

FIG. 5 depicts a sectional view of the solid state battery cell along line 5-5 in FIG. 4.

FIG. 6 depicts a sectional view of the solid state battery cell along line 6-6 in FIG. 4.

FIG. 7 depicts a perspective view of another illustrative solid state battery cell, according to one or more embodiments described.

FIG. 8 depicts a sectional view of the solid state battery cell along line 8-8 in FIG. 7.

FIG. 9 depicts a sectional view of the solid state battery cell along line 9-9 in FIG. 7.

FIG. 10 depicts a perspective view of another illustrative solid state battery cell, according to one or more embodiments described.

FIG. 11 depicts a sectional view of the solid state battery cell along line 11-11 in FIG. 10.

FIG. 12 depicts a sectional view of the solid state battery cell along line 12-12 in FIG. 10.

FIG. 13 depicts a schematic view of an illustrative solid state battery containing three solid state battery cells, according to one or more embodiments described.

FIG. 14 depicts a perspective view of an illustrative solid state coil battery, according to one or more embodiments described.

FIG. 15 depicts a top view of an illustrative solid state disk battery cell, according to one or more embodiments described.

FIG. 16 depicts a sectional view of the solid state disk battery cell along line 16-16 in FIG. 15.

FIG. 17 depicts a sectional view of an illustrative solid state container battery cell, according to one or more embodiments described.

FIG. 18 depicts a sectional view of the solid state container battery cell along line 18-18 in FIG. 17.

FIG. 19 depicts a sectional view of the solid state container battery cell along line 19-19 in FIG. 17.

FIG. 20 depicts a sectional view of another illustrative solid state container battery cell, according to one or more embodiments described.

FIG. 21 depicts a sectional view of the solid state container battery cell along line 21-21 in FIG. 20.

FIG. 22 depicts a sectional view of the solid state container battery cell along line 22-22 in FIG. 20.

FIG. 23 depicts a perspective view of another illustrative solid state battery, according to one or more embodiments described.

FIG. 24 depicts a sectional view of the solid state battery along line 24-24 in FIG. 23.

FIG. 25 depicts a sectional view of the solid state battery along line 25-25 in FIG. 23.

FIG. 26 depicts a graph of measured voltage over time in a recharge mode for an illustrative solid state battery, according to one or more embodiments.

FIG. 27 depicts a graph of measured voltage over time in a discharge mode for an illustrative solid state battery, according to one or more embodiments.

FIG. 28 depicts a graph of measured voltage over time in another discharge mode for an illustrative solid state battery, according to one or more embodiments.

FIG. 29 depicts a graph of measured voltage over time in a self-recovery mode for an illustrative solid state battery, according to one or more embodiments.

### DETAILED DESCRIPTION

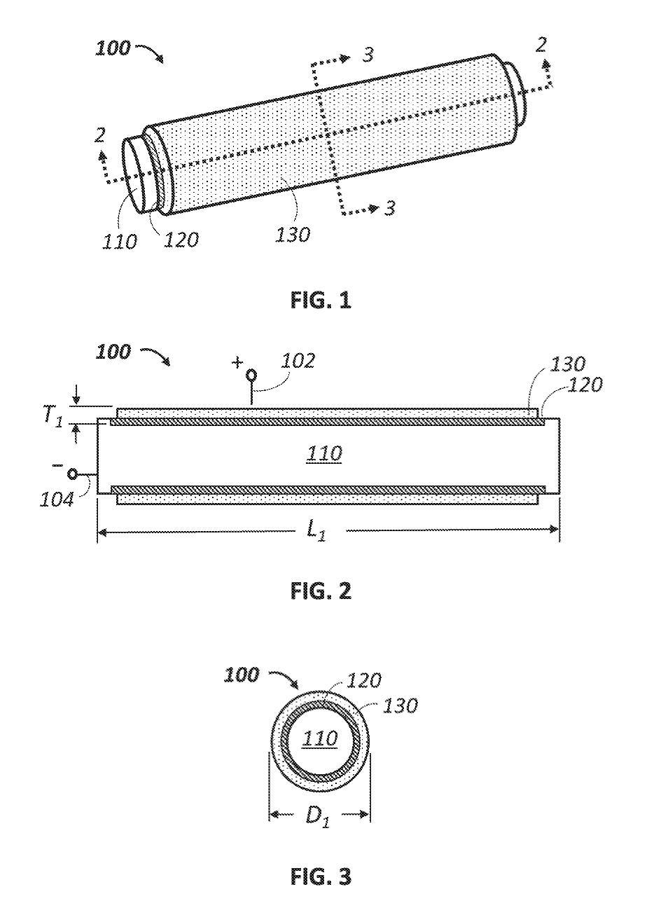

FIG. 1 depicts a perspective view of an illustrative solid state battery cell 100, according to one or more embodiments. FIG. 2 depicts a sectional view of the solid state battery cell 100 along line 2-2 in FIG. 1 and FIG. 3 depicts a sectional view of the solid state battery cell 100 along line 3-3 in FIG. 1. The solid state battery cell 100 can include one or more electrodes 110, one or more solid state ion conductors 120, and one or more counter electrodes 130. The solid state ion conductor 120 can be disposed at least partially between the electrode 110 and the counter electrode 130, as depicted in FIGS. 1-3.

The electrode 110 can be or include one or more magnesium-containing materials, the solid state ion conductor 120 can be or include one or more ion conductive materials, and the counter electrode 130 can be include one or more electrically conductive materials. The counter electrode 130 can also be or include one or more ion conductive substances. In some examples, the magnesium-containing material can be or include at least 90 atomic percent (at %) of magnesium, the ion conductive material can be or include one or more magnesium compounds, and the electrically conductive material can be or include graphite. The ion conductive substance, if present, can be or include one or more hydrates. One or more cathodes 102 can be connected to any portion of and/or in electrical communication with the counter electrode 130 and one or more anodes 104 can be connected to any portion of and/or in electrical communication with the electrode 110. The cathode 102 and the anode 104 can each independently include one or more wires, one or more buses, one or more electrically conductive materials, or any combination thereof.

The combined thickness (T₁) of the solid state ion conductor 120 and the counter electrode 130 can be about 1 μm, about 2 μm, about 5 μm, about 10 μm, about 20 μm, or about 50 μm to about 100 μm, about 250 μm, about 500 μm, about 750 μm, about 900 μm, or less than 1 mm. For example, the combined thickness (T₁) of the solid state ion conductor 120 and the counter electrode 130 can be about 1 μm to less than 1 mm, about 2 μm to about 500 μm, or about 2.5 μm to about 250 μm. The length (L₁) of the solid state battery cell 100 can be about 5 mm, about 10 mm, or about 50 mm to about 10 cm, about 50 cm, about 100 cm, about 500 cm, or about 1,000 cm. For example, the length (L₁) of the solid state battery cell 100 can be about 5 mm to about 1,000 cm, about 5 mm to about 10 cm, or about 5 mm to about 50 mm. The diameter (D₁) of the solid state battery cell 100 can be about 0.2 mm, about 1 mm, or about 5 mm to about 1 cm, about 10 cm, or about 50 cm. For example, the diameter (D₁) of the solid state battery cell 100 can be about 0.2 mm to about 50 cm, about 0.2 mm to about 10 cm, or about 1 mm to about 5 mm.

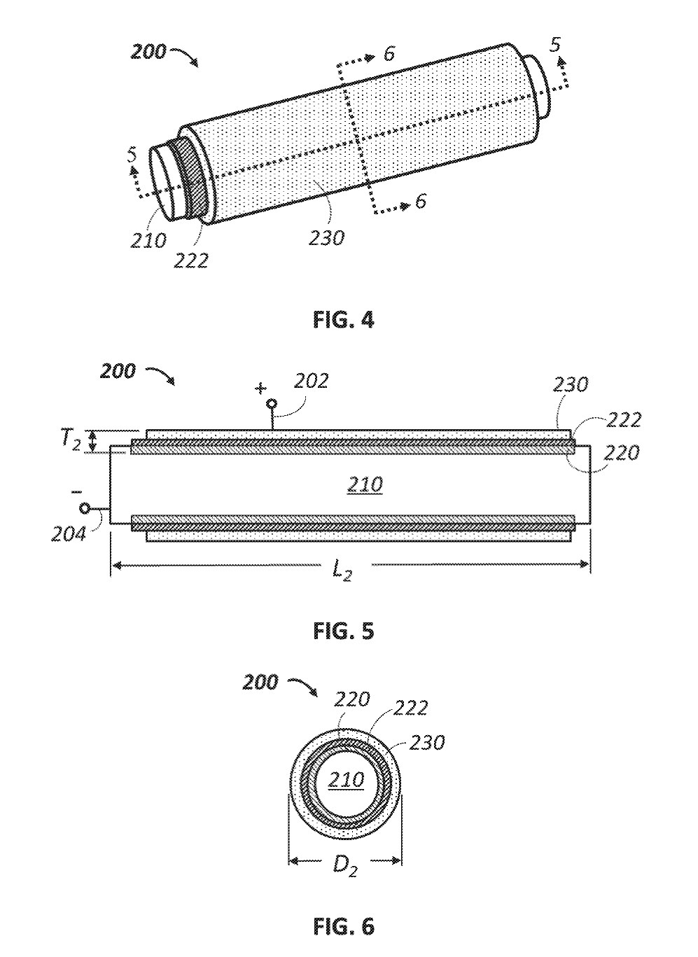

FIG. 4 depicts a perspective view of illustrative solid state battery cell 200, according to one or more embodiments. FIG. 5 depicts a sectional view of the solid state battery cell 200 along line 5-5 in FIG. 4 and FIG. 6 depicts a sectional view of the solid state battery cell 200 along line 6-6 in FIG. 4. The solid state battery cell 200 can include one or more electrodes 210, one or more solid state ion conductors 220, one or more secondary solid state conductors 222, and one or more counter electrodes 230. The solid state ion conductor 220 can be disposed at least partially between the electrode 210 and the counter electrode 230 and the secondary solid state conductor 222 can be disposed at least partially between the solid state ion conductor 220 and the counter electrode 230, as depicted in FIGS. 4-6.

The electrode 210 can be or include one or more magnesium-containing materials, the solid state ion conductor 220 can be or include one or more ion conductive materials, the secondary solid state conductor 222 can be or include one or more electrically conductive materials and/or one or more ion conductive materials, and the counter electrode 230 can be or include one or more electrically conductive materials and can also be or include one or more ion conductive substances. In some examples, the magnesium-containing material can be or include at least 90 at % of magnesium, the ion conductive material can be or include one or more magnesium compounds, the electrically conductive material in the secondary solid state conductor 222 can be or include graphite and the ion conductive substance in the secondary solid state conductor 222 can be or include one or more hydrates, one or more salts, one or more metal oxides, one or more metal hydroxides, and the electrically conductive material in the counter electrode 230 can be or include graphite and the ion conductive substance in the counter electrode 230 can be or include one or more hydrates. One or more cathodes 202 can be connected to any portion of and/or in electrical communication with the counter electrode 230 and one or more anodes 204 can be connected to any portion of and/or in electrical communication with the electrode 210. The cathode 202 and the anode 204 can each independently include one or more wires, one or more buses, one or more electrically conductive materials, or any combination thereof.

In some examples, the secondary solid state conductor 222 can be formed, deposited, or otherwise disposed on the solid state ion conductor 220 in order to cover, repair, or reduce defects disposed in the solid state ion conductor 220. The defects can be or include pin holes that electrically short the electrode 210 and the counter electrode 230 and/or can reduce the electrical contact resistance between the solid state ion conductor 220 and the counter electrode 230. The secondary solid state conductor 222 can also provide additional mobile anions or cations to improve ion conductance of the solid state ion conductor 220 and the counter electrode 230, enhance the redox reactions taking place on the electrode 210 and the counter electrode 230, and/or enhance one or more reactions with one or more gases and/or one or more liquids (e.g., air or water) that contact the counter electrode 230.

The combined thickness (T₂) of the solid state ion conductor 220, the secondary solid state conductor 222, and the counter electrode 230 can be about 1 μm, about 2 μm, about 5 μm, about 10 μm, about 20 μm, or about 50 μm to about 100 μm, about 250 μm, about 500 μm, about 750 μm, about 900 μm, or less than 1 mm. For example, the combined thickness (T₂) of the solid state ion conductor 220, the secondary solid state conductor 222, and the counter electrode 230 can be about 1 μm to less than 1 mm, about 2 μm to about 500 μm, or about 2.5 μm to about 250 μm. The length (L₂) of the solid state battery cell 200 can be about 5 mm, about 10 mm, or about 50 mm to about 10 cm, about 50 cm, about 100 cm, about 500 cm, or about 1,000 cm. For example, the length (L₂) of the solid state battery cell 200 can be about 5 mm to about 1,000 cm, about 5 mm to about 10 cm, or about 5 mm to about 50 mm. The diameter (D₂) of the solid state battery cell 200 can be about 0.2 mm, about 1 mm, or about 5 mm to about 1 cm, about 10 cm, or about 50 cm. For example, the diameter (D₂) of the solid state battery cell 200 can be about 0.2 mm to about 50 cm, about 0.2 mm to about 10 cm, or about 1 mm to about 5 mm.

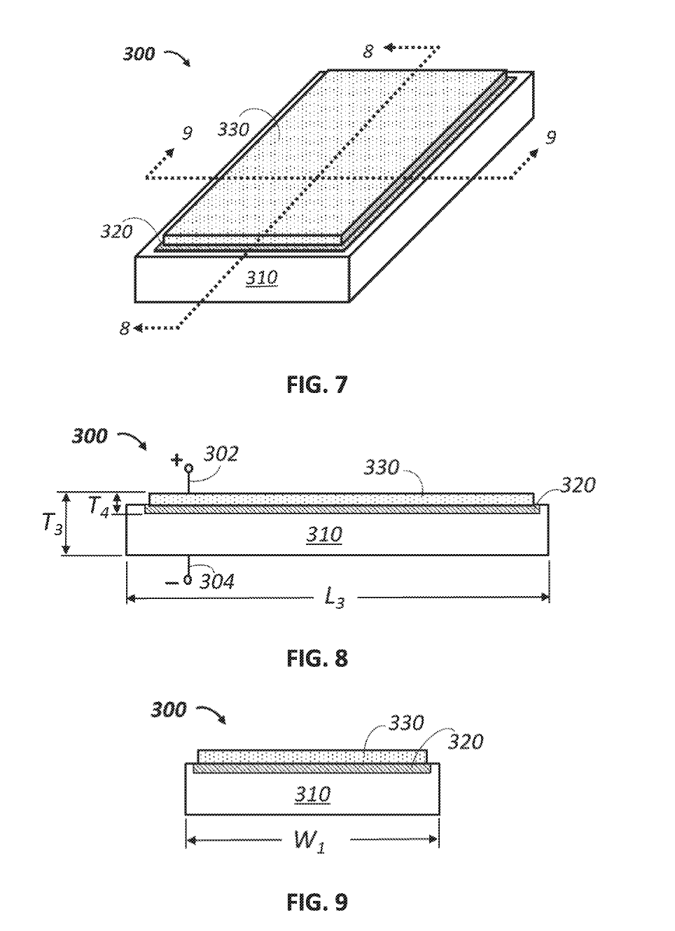

FIG. 7 depicts a perspective view of illustrative solid state battery cell 300, according to one or more embodiments. FIG. 8 depicts a sectional view of the solid state battery cell 300 along line 8-8 in FIG. 7 and FIG. 9 depicts a sectional view of the solid state battery cell 300 along line 9-9 in FIG. 7. The solid state battery cell 300 can include one or more electrodes 310, one or more solid state ion conductors 320, and one or more counter electrodes 330. The solid state ion conductor 320 can be disposed at least partially between the electrode 310 and the counter electrode 330, as depicted in FIGS. 7-9.

The electrode 310 can be or include one or more magnesium-containing materials, the solid state ion conductor 320 can be or include one or more ion conductive materials, and the counter electrode 330 can be or include one or more electrically conductive materials and can also be or include one or more ion conductive substances. In some examples, the magnesium-containing material can be or include at least 90 at % of magnesium, the ion conductive material can be or include one or more magnesium compounds, and the electrically conductive material can be or include graphite and the ion conductive substance can be or include one or more hydrates. One or more cathodes 302 can be connected to any portion of and/or in electrical communication with the counter electrode 330 and one or more anodes 304 can be connected to any portion of and/or in electrical communication with the electrode 310. The cathode 302 and the anode 304 can each independently include one or more wires, one or more buses, one or more electrically conductive materials, as discussed and described herein, or any combination thereof.

The thickness (T₃) of the solid state battery cell 300 can be about 0.05 mm, about 0.5 mm, or about 1 mm to about 10 mm, about 50 mm, or about 100 mm. For example, the thickness (T₃) of the solid state battery cell 300 can be about 0.05 mm to about 100 mm, about 0.5 mm to about 30 mm, or about 0.5 mm to about 1 mm. The combined thickness (T₄) of the solid state ion conductor 320 and the counter electrode 330 can be about 1 μm, about 2 μm, about 5 μm, about 10 μm, about 20 μm, or about 50 μm to about 100 μm, about 250 μm, about 500 μm, about 750 μm, about 900 μm, or less than 1 mm. For example, the combined thickness (T₄) of the solid state ion conductor 320 and the counter electrode 330 can be about 1 μm to less than 1 mm, about 2 μm to about 500 μm, or about 2.5 μm to about 250 μm.

The length (L₃) of the solid state battery cell 300 can be about 2 mm, about 5 mm, about 10 mm, or about 50 mm to about 10 cm, about 50 cm, about 100 cm, or about 500 cm. For example, the length (L₃) of the solid state battery cell 300 can be about 2 mm to about 500 cm, about 2 mm to about 10 cm, or about 2 mm to about 10 mm. The width (W₁) of the solid state battery cell 300 can be about 2 mm, about 10 mm, or about 50 mm to about 10 cm, about 100 cm, or about 500 cm. For example, the width (W₁) of the solid state battery cell 300 can be about 2 mm to about 500 cm, about 2 mm to about 50 cm, or about 2 mm to about 10 cm.

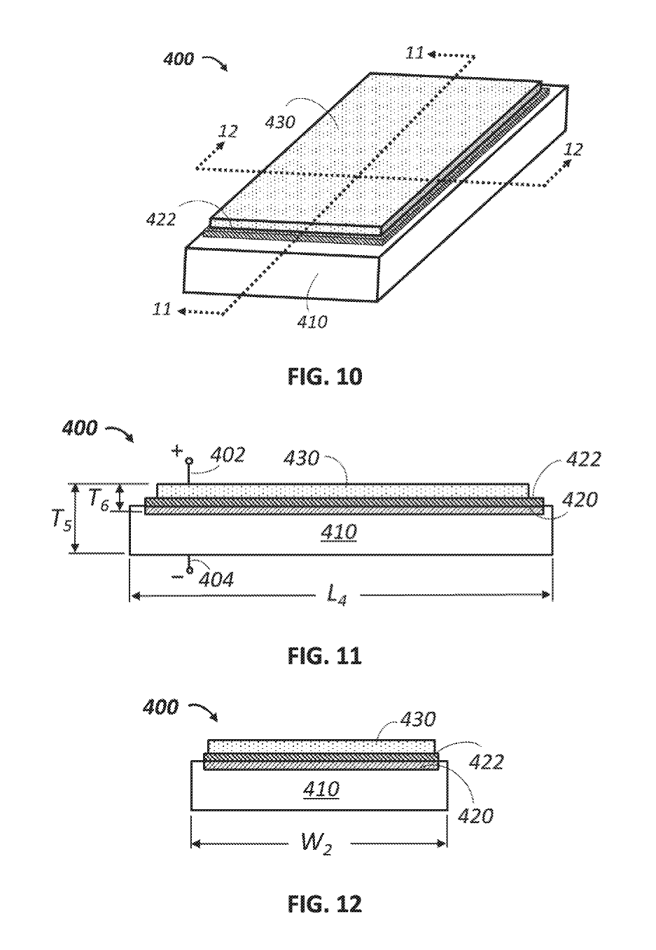

FIG. 10 depicts a perspective view of an illustrative solid state battery cell 400, according to one or more embodiments. FIG. 11 depicts a sectional view of the solid state battery cell 400 along line 11-11 in FIG. 10 and FIG. 12 depicts a sectional view of the solid state battery cell 400 along line 12-12 in FIG. 10. The solid state battery cell 400 can include one or more electrodes 410, one or more solid state ion conductors 420, one or more secondary solid state conductors 422, and one or more counter electrodes 430. The solid state ion conductor 420 can be disposed at least partially between the electrode 410 and the counter electrode 430 and the secondary solid state conductor 422 can be disposed at least partially between the solid state ion conductor 420 and the counter electrode 430, as depicted in FIGS. 10-12.

The electrode 410 can be or include one or more magnesium-containing materials, the solid state ion conductor 420 can be or include one or more ion conductive materials, the secondary solid state conductor 422 can be or include one or more electrically conductive materials and/or one or more ion conductive materials, and the counter electrode 430 can be or include one or more electrically conductive materials and can also be or include one or more ion conductive substances. In some examples, the magnesium-containing material contained in the electrode 410 can be or include at least 90 at % of magnesium, the ion conductive material contained in the solid state ion conductor 420 can be or include one or more magnesium compounds, the electrically conductive material contained in the secondary solid state conductor 422 can be or include graphite and the ion conductive substance contained in the secondary solid state conductor 422 can be or include one or more hydrates, one or more salts, one or more metal oxides, one or more metal hydroxides, and the electrically conductive material contained in the counter electrode 430 can be or include graphite and the ion conductive substance contained in the counter electrode 430 can be or include one or more hydrates. One or more cathodes 402 can be connected to any portion of and/or in electrical communication with the counter electrode 430 and one or more anodes 404 can be connected to any portion of and/or in electrical communication with the electrode 410. The cathode 402 and the anode 404 can each independently include one or more wires, one or more buses, one or more electrically conductive materials, as discussed and described herein, or any combination thereof.

In some examples, the secondary solid state conductor 422 can be formed, deposited, or otherwise disposed on the solid state ion conductor 420 in order to cover, repair, or reduce defects disposed in the solid state ion conductor 420. The defects can be or include pin holes that electrically short the electrode 410 and the counter electrode 430 and/or can reduce the electrical contact resistance between the solid state ion conductor 420 and the counter electrode 430. The secondary solid state conductor 422 can also provide additional mobile anions or cations to improve ion conductance of the solid state ion conductor 420 and the counter electrode 430, enhance the redox reactions taking place on the electrode 410 and the counter electrode 430, and/or enhance one or more reactions with one or more gases and/or one or more liquids (e.g., air or water) that contact the counter electrode 430.

The thickness (T₅) of the solid state battery cell 400 can be about 0.05 mm, about 0.5 mm, or about 1 mm to about 10 mm, about 50 mm, or about 100 mm. For example, the thickness (T₅) of the solid state battery cell 400 can be about 0.05 mm to about 100 mm, about 0.5 mm to about 30 mm, or about 0.5 mm to about 1 mm. The combined thickness (T₆) of the solid state ion conductor 420, the secondary solid state conductor 422, and the counter electrode 430 can be about 1 μm, about 2 μm, about 5 μm, about 10 μm, about 20 μm, or about 50 μm to about 100 μm, about 250 μm, about 500 μm, about 750 μm, about 900 μm, or less than 1 mm. For example, the combined thickness (T₆) of the solid state ion conductor 420, the secondary solid state conductor 422, and the counter electrode 430 can be about 1 μm to less than 1 mm, about 2 μm to about 500 μm, or about 2.5 μm to about 250 μm.

The length (L₄) of the solid state battery cell 400 can be about 2 mm, about 5 mm, about 10 mm, or about 50 mm to about 10 cm, about 50 cm, about 100 cm, or about 500 cm. For example, the length (L₄) of the solid state battery cell 400 can be about 2 mm to about 500 cm, about 2 mm to about 10 cm, or about 2 mm to about 10 mm. The width (W₂) of the solid state battery cell 400 can be about 2 mm, about 10 mm, or about 50 mm to about 10 cm, about 100 cm, or about 500 cm. For example, the width (W₂) of the solid state battery cell 400 can be about 2 mm to about 500 cm, about 2 mm to about 50 cm, or about 2 mm to about 10 cm.

### Electrode

In at least one embodiment, the electrodes 110, 210, 310, and/or 410 and at least a portion of the solid state ion conductors 120, 220, 320, and/or 420 can be made, produced, or otherwise derived from the same magnesium-containing substrate. For example, the magnesium compound in the solid state ion conductors 120, 220, 320, and/or 420 can be made, produced, or otherwise derived from a first portion of the magnesium-containing substrate and the magnesium in the electrodes 110, 210, 310, and/or 410 can be made, produced, or otherwise derived from a second portion of the magnesium-containing substrate. In some examples, the first portion of the magnesium-containing substrate can be converted to produce the solid state ion conductors 120, 220, 320, and/or 420 or at least a portion of the solid state ion conductors 120, 220, 320, and/or 420 and the remainder or the second portion of the magnesium-containing substrate can be or include the electrodes 110, 210, 310, and/or 410. The solid state ion conductors 120, 220, 320, and/or 420 can be continuously or discontinuously disposed on one or more portions of the electrodes 110, 210, 310, and/or 410.

The electrodes 110, 210, 310, and/or 410 can be or include one or more magnesium-containing substrates and/or one or more portions of magnesium-containing substrates. The magnesium-containing substrate can be or include, but is not limited to, one or more of: a wire, a rod, a foil, a sheet, a plate, a film, a disk, a strip, a container, a conduit, a pipe, an end cap, a plug, or any combination thereof. In some examples, the magnesium-containing substrate used to produce the electrodes 110 and/or 210 and the solid state ion conductors 120 and/or 220, depicted in FIGS. 1-3 and 4-6, respectively, can be one or more wires or one or more rods. In other examples, the magnesium-containing substrate used to produce the electrodes 310 and/or 410 and the solid state ion conductors 320 and/or 420, depicted in FIGS. 7-9 and 10-12, respectively, can be one or more plates, one or more films, or one or more strips.

The electrodes 110, 210, 310, and/or 410 and the magnesium-containing substrate can be or include at least 90 at % of magnesium. For example, the electrodes 110, 210, 310, and/or 410 and the magnesium-containing substrate can include at least 91 at %, at least 92 at %, at least 93 at %, at least 94 at %, at least 95 at %, at least 96 at %, at least 97 at %, at least 98 at %, at least 99 at %, at least 99.5 at %, at least 99.8 at %, at least 99.9 at %, at least 99.95 at %, at least 99.99 at %, or more of magnesium. For example, the electrodes 110, 210, 310, and/or 410 and the magnesium-containing substrate can include about 90 at % to about 100 at %, about 92 at % to about 99.99 at %, about 95 at % to about 99.9 at %, or about 95 at % to about 99 at % of magnesium.

In other examples, the electrodes 110, 210, 310, and/or 410 and the magnesium-containing substrate can include one or more elements or one or more metals other than magnesium. Illustrative elements or metals other than magnesium can be or include, but are not limited to, aluminum, silver, zinc, silicon, manganese, scandium, yttrium, lanthanide, cerium, praseodymium, neodymium, promethium, samarium, europium, gadolinium, terbium, dysprosium, holmium, erbium, thulium, ytterbium, lutetium, alloys thereof, or any mixture thereof. The electrodes 110, 210, 310, and/or 410 and the magnesium-containing substrate can include about 10 at % or less of one or more elements or one or more metals other than magnesium. For example, the electrodes 110, 210, 310, and/or 410 and the magnesium-containing substrate can include about 0.01 at %, about 0.1 at %, about 0.5 at %, about 1 at %, about 2 at %, about 3 at %, or about 4 at % to about 5 at %, about 6 at %, about 7 at %, about 8 at %, about 9 at %, or about 10 at % of one or more elements or one or more metals other than magnesium. In one or more examples, the electrodes 110, 210, 310, and/or 410 and the magnesium-containing substrate can include at least 90 at % of magnesium and can include about 1 at % to about 7 at %, about 2 at % to about 5 at %, or about 3 at % to about 4 at % of aluminum.

### Solid State Ion Conductor

The solid state ion conductors 120, 220, 320, and/or 420 can include, but are not limited to, one or more ion conductive materials. The ion conductive materials can be or include, but are not limited to, one or more magnesium compounds, one or more hydrates or hydrated materials, one or more salts or ionic compounds, or any mixture thereof. In some examples, the ion conductive material can have an ionic conductivity of greater than 1×10⁻⁸ S/cm and can have an electron conductivity of 1×10⁻⁸ S/cm or less.

The ion conductive material that can be contained in the solid state ion conductors 120, 220, 320, and/or 420 can be or include one or more magnesium compounds. Illustrative magnesium compounds can be or include, but are not limited to, magnesium oxide, magnesium hydroxide, magnesium peroxide, magnesium chloride, magnesium perchlorate, magnesium chlorite, magnesium hypochlorite, magnesium sulfate, magnesium sulfite, magnesium carbonate, magnesium cyanide, magnesium acetate, magnesium formate, magnesium hydrogen carbonate, magnesium nitride, magnesium nitrate, magnesium borate, magnesium aluminum sulfate, magnesium aluminum silicate, magnesium aluminum oxide, or any combination thereof.

The ion conductive material that can be contained in the solid state ion conductors 120, 220, 320, and/or 420 can be or include one or more hydrated materials. In some examples, the hydrated material can be or include one or more hydrate complexes that can have one or more water molecules chemically bonded to one or more substances, such as, one or more of: an element, a compound, a material, or any mixture thereof. The hydrate complex can include one or more water molecules chemically bonded to the surface of the substance or incorporated into a crystalline structure of the substance.

In some examples, the hydrated material can be or include, but is not limited to, a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof. For example, the hydrated material can be or include, but is not limited to, magnesium sulfate hydrate, copper sulfate hydrate, potassium aluminum sulfate hydrate, cobalt chloride hydrate, magnesium acetate hydrate, vanadium oxide hydrate, iron oxide hydrate, sodium calcium aluminum magnesium silicate hydroxide hydrate, magnesium silicate hydrate, hydrated aluminum silicate, iron cyanide hydrate, magnesium borate hydrate, magnesium nitrate hydrate, hydrates thereof, isomers thereof, or any combination thereof.

In some specific examples, the hydrated material can be or include, but is not limited to, magnesium sulfate hydrate (e.g., MgSO₄.7H₂O), copper sulfate hydrate (e.g., CuSO₄.5H₂O), potassium aluminum sulfate hydrate (e.g., KAl(SO₄)₂.12H₂O), cobalt chloride hydrate (e.g., CoCl₂.6H₂O), magnesium acetate hydrate (e.g., Mg(CH₃COO)₂.4H₂O), vanadium oxide hydrate (e.g., V₂O₅.3H₂O), iron oxide hydrate (e.g., Fe₂O₃.H₂O), sodium calcium aluminum magnesium silicate hydroxide hydrate (e.g., (Na,Ca)_{0.33}(Al,Mg)₂(Si₄O₁₀)(OH)₂.nH₂O, where n can be about 1 to about 10), magnesium silicate hydrate (e.g., MgO.mSiO₂.H₂O, where m can be about 1 to about 3), hydrated aluminum silicate (e.g., Al₂O₃.2SiO₂.2H₂O), iron cyanide hydrate (e.g., Fe₇(CN)₁₈.pH₂O, where p can be about 14 to about 16), hydrates thereof, other metal oxidation states thereof, isomers thereof, or any combination thereof.

The hydrated material can include one or more mobile ions. The mobile ion can be formed or otherwise generated in the hydrated material by one or more electrical currents flowing through the solid state battery cell 100. Each mobile ion can have a hydrated radius of about 0.05 nm to less than 0.5 nm, about 0.1 nm to less than 0.5 nm, about 0.1 nm to less than 0.4 nm, or about 0.3 nm to less than 0.5 nm.

The hydrated material can be or include, but is not limited to, one or more salts and/or one or more ionic compounds. The salt or the ionic compound can include one or more cations, one or more anions, one or more hydrates (water molecules), or any mixture thereof. The cation can be or include, but is not limited to, cations of copper, iron, zinc, tin, aluminum, manganese, titanium, sodium, potassium, cesium, magnesium, calcium, vanadium, beryllium, cerium, or any mixture thereof. For example, the cation can be or include, Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof. The anion can be or include, but is not limited to, perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

In one or more embodiments, the solid state ion conductors 120, 220, 320, and/or 420 can include two or more ion conductors, such as a first ion conductor and a second ion conductor. The first ion conductor can be disposed on the electrodes 110, 210, 310, and/or 410 and can include the ion conductive material and the second ion conductor can be disposed on the first ion conductor. Each of the first ion conductor and the second ion conductor can independently include one or more hydrated materials. Hydration or water concentration of the solid state ion conductor can be about 1 ppb (part per billion or 0.0000001 wt %), about 1 ppm (part per million or 0.0001 wt %), or about 10 ppm (0.001 wt %) of water to about 1 wt %, about 10 wt %, or about 75 wt % of water.

### Counter Electrode

The counter electrodes 130, 230, 330, and/or 430 and the secondary solid state conductors 232 and/or 432 can independently include one or more electrically conductive materials, one or more ion conductive substances, or a combination or mixture of one or more electrically conductive materials and one or more ion conductive substances. The ion conductive substance can be or include any one of the ion conductive materials discussed and described herein.

The electrically conductive materials in the counter electrodes 130, 230, 330, and/or 430 can be or include, but are not limited to, one or more metals, one or more conductive polymers, graphite, one or more graphite materials, one or more graphite compounds, or any combination thereof. Illustrative metals can be or include, but are not limited to, silver, nickel, gold, copper, aluminum, alloys thereof, or any mixture thereof. The metal can be in a form of particles, one or more films, one or more plates, one or more wires, or any mixture thereof. In other examples, the electrically conductive materials can be or include one or more conductive polymers or conductive polymeric materials. Illustrative conductive polymers and conductive polymeric materials can be or include, but are not limited to, a poly(3,4-ethylenedioxythiophene) polystyrene sulfonate (PEDOT:PSS), a polyaniline (PANI), a polythiophene (PT), a polypyrrole (PPy), copolymers thereof, derivatives thereof, or any mixture thereof.

In some examples, the counter electrodes 130, 230, 330, and/or 430 can include graphite, one or more graphite compounds, one or more graphite materials, or any mixture thereof. In other examples, the counter electrodes 130, 230, 330, and/or 430 can include one or more of the ion conductive substances and also include graphite, one or more graphite compounds, one or more graphite materials, or any mixture thereof. The graphite, graphite compound, and the graphite material can be in a form of, but are not limited to, flakes, powders, fibers, foams, or a layered film or material. The graphite, the graphite compound, or the graphite material can be or include, but is not limited to, a plurality of monolayers such as graphene or doped graphene, including one or more graphene compounds, one or more elements incorporated between graphene layers, one or more compounds incorporated between graphene layers, or any mixture thereof. Illustrative graphene compounds can be or include, but is not limited to, graphene oxide, graphene perchlorate, graphene bisulfate, or any mixture thereof. Graphite can be doped with one or more metals that can be or include, but is are not limited to, copper, silver, aluminum, an alloy thereof, or any mixture thereof. Graphite intercalated with one or more elements incorporated between graphene layers can be or include, but is not limited to, graphite intercalated with sodium, potassium, lithium, rubidium, magnesium, calcium, beryllium, erbium, ytterbium, an ion thereof, an alloy thereof, or any mixture thereof.

Graphite intercalated with one or more compounds incorporated between graphene layers can be or include, but is not limited to, graphite intercalated with one or more ionic compounds and/or one or more salts. The ionic compound or the salt can include one or more cations, one or more anions, one or more hydrates (water molecules), or any mixture thereof. The cation can be or include, but is not limited to, cations of copper, iron, zinc, tin, aluminum, manganese, titanium, sodium, potassium, cesium, magnesium, calcium, vanadium, beryllium, cerium, or any mixture thereof. For example, the cation can be or include, Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof. The anion can be or include, but is not limited to, perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof. In some examples, graphite can be intercalated with one or more metal halides. The metal halides can be or include, but are not limited to, zinc chloride, copper chloride, nickel chloride, manganese chloride, aluminum chloride, iron chloride, gallium chloride, zirconium chloride, or any mixture thereof.

In other embodiments, the ion conductive substance contained in the counter electrodes 130, 230, 330, and/or 430 can be or include one or more salts. The salt can include one or more cations, one or more anions, one or more hydrates (water molecules), or any mixture thereof. The cation can be or include, but is not limited to, cations of aluminum, ammonium, calcium, cesium, copper, iron, magnesium, manganese, potassium, sodium, tin, zinc, or any mixture thereof. The anion can be or include, but is not limited to, chloride, perchlorate, chlorite, hypochlorite, sulfate, sulfite, hydrogen sulfate, carbonate, hydrogen carbonate, cyanide, acetate, formate, acrylate, or any mixture thereof.

In some examples, the ion conductive substance can be or include, but is not limited to, one or more metal oxides and one or more salts. The metal oxide can be or include, but is not limited to, magnesium oxide, tin oxide, aluminum oxide, iron oxide, copper oxide, zinc oxide, vanadium oxide, cerium oxide, or any mixture thereof. In other examples, the ion conductive substance can be or include, but is not limited to, one or more metal hydroxides and one or more salts. The metal hydroxide can be or include, but is not limited to, potassium hydroxide, sodium hydroxide, lithium hydroxide, cesium hydroxide, magnesium hydroxide, calcium hydroxide, aluminum hydroxide, or any mixture thereof. In other examples, the ion conductive substance can be or include, but is not limited to, one or more metal peroxides and one or more salts. The metal peroxide can be or include, but is not limited to, potassium peroxide, sodium peroxide, lithium peroxide, cesium peroxide, magnesium peroxide, calcium peroxide, or any mixture thereof. In one or more examples, the ion conductive substance can be or include, but is not limited to, magnesium oxide, magnesium peroxide, magnesium hydroxide, or any mixture thereof.

The ion conductive substance can also be or include, but is not limited to, a hydrated material. The hydrated material can be or include, but is not limited to, a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof. The ion conductive substance can be or include, but is not limited to, a crystalline layered material containing a plurality of monolayers disposed on one another. For example, the crystalline layered material can be or include vanadium oxide, graphene oxide, molybdenum sulfide, or any mixture thereof. In some examples, the ion conductive substance can be or include, but is not limited to, a mixture containing two or more substances that can provide an ion conductive path along the interface between the two or more substances. For example, the mixture can include a first substance (e.g., magnesium oxide) and a second substance (e.g., aluminum oxide, silicon oxide, or aluminum silicate), and the ion conductive path can flow, extend, or otherwise exist along the interface between the first substance and the second substance.

In one or more embodiments, the counter electrodes 130, 230, 330, and/or 430 can include one or more composite materials. Illustrative composite materials can be or include, but are not limited to, one or more of the electrically conductive materials, one or more ion conductive substances, or a combination or a mixture of one or more electrically conductive materials and one or more ion conductive substances. In some examples, the composite material can be or include, but is not limited to, multiple layers of different ratios of electrically conductive material to ion conductive material, different compositions, a variety of hydrated material concentrations, and/or different hydrations. In some examples, the composite material can be or include, but is not limited to, one or more compounds that react or enhance the reaction with air exposed to the counter electrode, and the counter electrode can be a reaction mediator or a current collector (e.g., metal-air battery cell). The ratio of electrically conductive material to ion conductive material can be about 1%, about 5%, or about 10% to about 50%, about 80%, or about 99%. Hydration or water concentration of the counter electrode can be about 1 ppb, about 1 ppm, or about 10 ppm of water to about 1 wt %, about 10 wt %, or about 75 wt % of water.

In other embodiments, one or more surfaces of the solid state ion conductors 120, 220, 320, and/or 420 and one or more surfaces of the counter electrodes 130, 230, 330, and/or 430 can contact each other producing one or more interfaces disposed therebetween. The surface of the counter electrode 130 at the interface can have a roughness of about 0.005 μm to about 1,000 μm or about 0.005 μm to about 500 μm, as measured according to ASTM D7127-2013. The surface of the solid state ion conductors 120, 220, 320, and/or 420 at the interface can have a roughness of about 0.01 μm to about 100 μm, as measured according to ASTM D7127-2013.

In one or more embodiments, the solid state ion conductors 120, 220, 320, and/or 420 can have a relatively high ion conductance and a relatively low electron conductance, working as a solid state electrolyte. Because of the ion conduction nature of the solid state ion conductors 120, 220, 320, and/or 420, an electrical potential between the electrodes is produced with respect to the standard electrode potential difference between the electrodes 110, 210, 310, and/or 410 and the counter electrodes 130, 230, 330, and/or 430 and the corresponding redox reaction. In the solid state battery cells 100, 200, 300, and/or 400, the electrodes 110, 210, 310, and/or 410 and/or the anodes 104, 204, 304, and/or 404 can be the negative battery terminal and the counter electrodes 130, 230, 330, and/or 430 and/or the cathodes 102, 202, 302, and/or 402 can be a positive battery terminal. Once one or more external loads are connected the electrodes 110, 210, 310, and/or 410 (and/or the anodes 104, 204, 304, and/or 404) and the counter electrodes 130, 230, 330, and/or 430 (and/or the cathodes 102, 202, 302, and/or 402), an electrical current can flow through the external load.

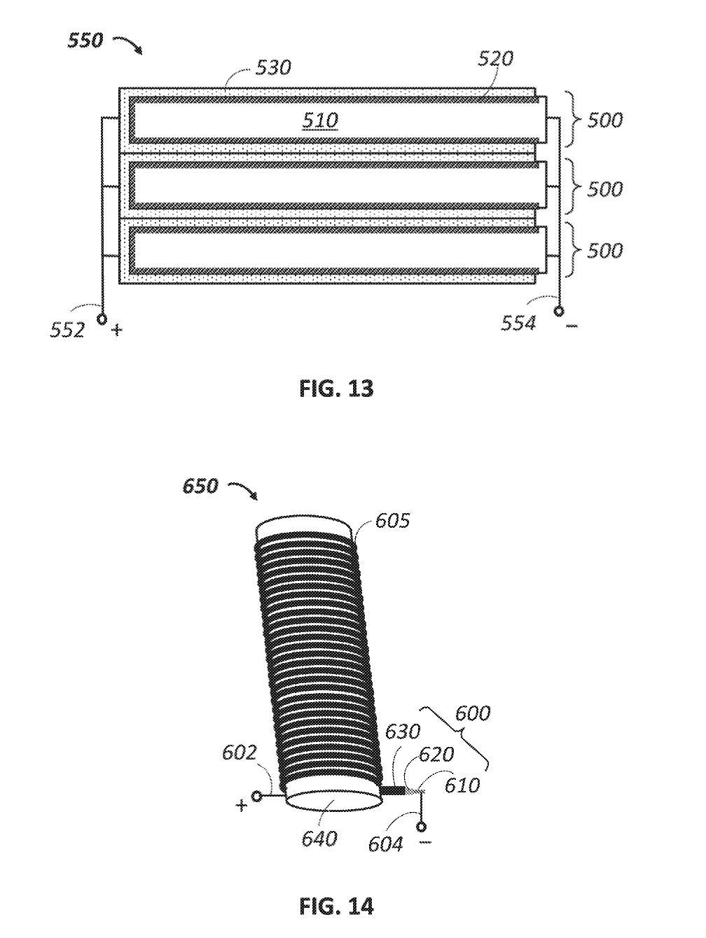

FIG. 13 depicts a schematic view of an illustrative solid state battery 550 that includes three solid state battery cells 500, according to one or more embodiments. Although the solid state battery 550 is shown in FIG. 13 with three solid state battery cells 500, the solid state battery 550 can include any number of the solid state battery cells 500. For example, the solid state battery 550 can include 2, 3, 4, 5, 6, 7, 8, 9, 10, 11, or 12 to about 15, about 18, about 20, about 24, about 30, about 40, about 50, or more of the solid state battery cells 500. In some examples, the solid state battery 550 can include 2 to about 50, 2 to about 30, 3 to about 18, or 3 to 12 of the solid state battery cells 500.

Each of the solid state battery cells 500 can include one or more electrodes 510, one or more solid state ion conductors 520, one or more secondary solid state conductors (not shown), and one or more counter electrodes 530. The solid state ion conductor 520 can be disposed at least partially between the electrode 510 and the counter electrode 530. If the solid state battery 550 includes the secondary solid state conductor, then the secondary solid state conductor can be disposed at least partially between the solid state ion conductor 520 and the counter electrode 530.

In one or more embodiments, any of the solid state battery cells 100, 200, 300, and/or 400, as shown in FIGS. 1-12 and discussed and described herein, can be any one or more of the solid state battery cells 500 contained in the solid state battery 550. The solid state battery cells 100, 200, 300, and/or 400 can be in any amount and in any combination or mixture to produce in the solid state battery 550.

As further depicted in FIG. 13, the solid state battery 550 can include one or more cathodes 552 and one or more anodes 554. The cathode 552 can be connected to any portion of and/or in electrical communication with each of the counter electrodes 530 and the anode 554 can be connected to any portion of and/or in electrical communication with each of the electrodes 510. When any one or more of the solid state battery cells 100, 200, 300, and/or 400 are included in the solid state battery 550, the one or more cathodes 102, 202, 302, and/or 402 and the one or more anodes 104, 204, 304, and/or 404 from the solid state battery cells 100, 200, 300, and/or 400 can be connected to any portion of and/or in electrical communication with the cathodes 552 and the anodes 554, respectively. The cathode 552 and the anode 554 can each independently include one or more wires, one or more buses, one or more electrically conductive materials, as discussed and described herein, or any combination thereof.

FIG. 14 depicts a perspective view of an illustrative solid state coil battery 650, according to one or more embodiments. The solid state coil battery 650 can include one or more solid state battery cells 600 partially or completely encompassing or wrapping around one or more cores 640. The solid state battery cell 600 can be wrapped around the core 640 to form or produce one or more coils 605, as depicted in FIG. 14. The core 640 can be electrically conductive and can be or include one or more electrically conductive materials. Illustrative electrically conductive materials can be or include, but are not limited to, one or more of metals, including copper, nickel, aluminum, silver, gold, steel, iron, alloys thereof, or any mixture thereof; graphite; one or more conducting polymeric material; or any mixture thereof.

Each of the solid state battery cells 600 can include one or more electrodes 610, one or more solid state ion conductors 620, one or more secondary solid state conductors (not shown), and one or more counter electrodes 630. The solid state ion conductor 620 can be disposed at least partially between the electrode 610 and the counter electrode 630. If the solid state battery 650 includes the secondary solid state conductor, then the secondary solid state conductor can be disposed at least partially between the solid state ion conductor 620 and the counter electrode 630. In one or more embodiments, any of the solid state battery cells 100, 200, 300, and/or 400, as shown in FIGS. 1-12 and discussed and described herein, can be any the solid state battery cell 600 contained in the solid state coil battery 650. The solid state coil battery 650 can include one or more cathodes 602 and one or more anodes 604. The cathode 602 can be connected to any portion of and/or in electrical communication with the core 640 and/or the counter electrode 630 and the anode 604 can be connected to any portion of and/or in electrical communication with each of the electrode 610. The cathode 602 and the anode 602 can each independently include one or more wires, one or more buses, one or more electrically conductive materials, as discussed and described herein, or any combination thereof.

In one or more embodiments, the solid state coil battery 650 can include two or more coils 605, such as a plurality of coils 605, of the solid state battery cell 600 encompassing or otherwise wrapping around the core 640. The solid state coil battery 650 can include 2, 3, 4, 5, 6, 7, 8, 9, 10, 11, or 12 to about 15, about 18, about 20, about 24, about 30, about 40, about 50, about 75, about 90, about 100, or more of the coils 605 of the solid state battery cell 600 wrapping the core 640. For example, the solid state coil battery 650 can include 3 coils to about 100 coils.

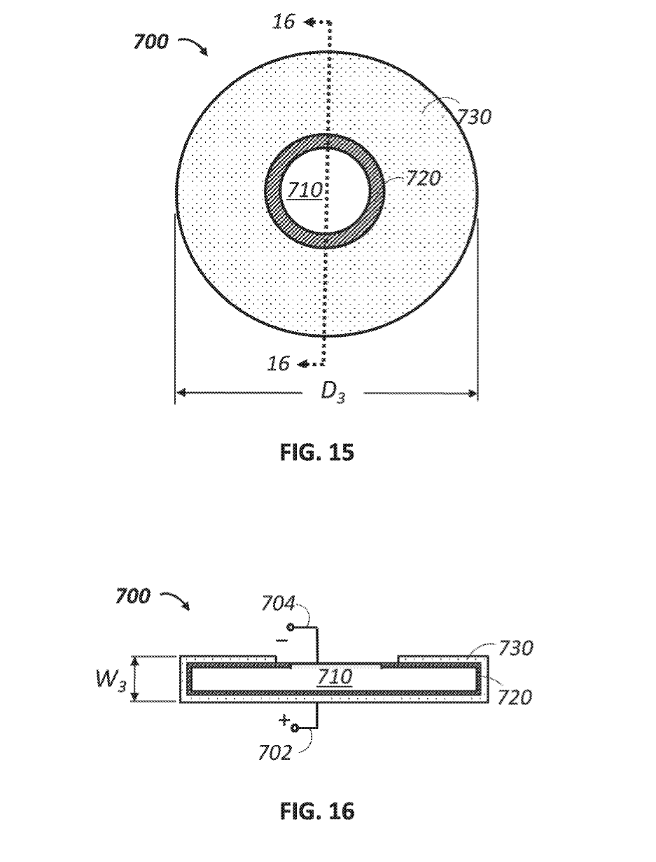

FIG. 15 depicts a top view of an illustrative solid state disk battery cell 700, according to one or more embodiments. FIG. 16 depicts a sectional view of the solid state disk battery cell 700 along line 16-16 in FIG. 15. The solid state disk battery cell 700 can include one or more electrodes 710, one or more solid state ion conductors 720, one or more secondary solid state conductors (not shown), and one or more counter electrodes 730. The solid state ion conductor 720 can be disposed at least partially between the electrode 710 and the counter electrode 730. The solid state ion conductor 720 can be continuously or discontinuously disposed on one or more portions of the electrode 710. If the solid state battery 750 includes the secondary solid state conductor, then the secondary solid state conductor can be disposed at least partially between the solid state ion conductor 720 and the counter electrode 730. One or more cathodes 702 can be connected to any portion of and/or in electrical communication with the counter electrode 730 and one or more anodes 704 can be connected to any portion of and/or in electrical communication with the electrode 710. The cathode 702 and the anode 704 can each independently include one or more wires, one or more buses, one or more electrically conductive materials, as discussed and described herein, or any combination thereof.

In some embodiments, the solid state ion conductor 720 can be disposed on or otherwise formed on one or more first portions of the electrode 710, while one or more second portions of the electrode 710 can be free of the solid state ion conductor 720. For example, the solid state ion conductor 720 can be disposed on the lower surface, the side or end surfaces, and a portion of the upper surface of the electrode 710 and the remaining portioning of the upper surface of the electrode 710 can be free of the solid state ion conductor 720, as depicted in FIGS. 15 and 16. Also, the counter electrode 730 can be disposed on or otherwise formed on one or more first portions of the solid state ion conductor 720, while one or more second portions of the solid state ion conductor 720 can be free of the counter electrode 730. For example, the counter electrode 730 can be disposed on the lower surface, the side or end surfaces, and a portion of the upper surface of the solid state ion conductor 720 and the remaining portioning of the upper surface of the solid state ion conductor 720 can be free of the counter electrode 730.

The electrode 710 can be or include one or more magnesium-containing materials, the solid state ion conductor 720 can be or include one or more ion conductive materials, and the counter electrode 730 can be or include one or more electrically conductive materials and can also be or include one or more ion conductive substances. In one or more embodiments, the electrode 710 can include the same magnesium-containing materials as discussed and described above for the electrodes 110, 210, 310, and/or 410; the solid state ion conductor 720 can be or include one or more ion conductive materials as discussed and described above for the solid state ion conductors 120, 220, 320, and/or 420; and the counter electrode 730 can be or include one or more electrically conductive materials and can also be or include one or more ion conductive substances as discussed and described above for the counter electrodes 130, 230, 330, and/or 430. In some examples, the magnesium-containing material contained in the electrode 710 can be or include at least 90 at % of magnesium, the ion conductive material contained in the solid state ion conductor 720 can be or include one or more magnesium compounds, and the electrically conductive material contained in the counter electrode 730 can be or include graphite and the ion conductive substance contained in the counter electrode 730 can be or include one or more hydrates. In one or more examples, the magnesium-containing substrate used to produce the electrode 710 and the solid state ion conductor 720 can be one or more magnesium-containing disks or one or more magnesium-containing films.

The diameter (D₃) of the solid state disk battery cell 700 can be about 2 mm, about 5 mm, or about 10 mm to about 5 cm, about 50 cm, or about 100 cm. For example, the diameter (D₃) of the solid state disk battery cell 700 can be about 2 mm to about 100 cm, about 2 mm to about 40 cm, or about 5 mm to about 10 cm. The width (W₃) of the solid state disk battery cell 700 can be about 0.1 mm, about 1 mm, or about 5 mm to about 1 cm, about 5 cm, about 10 cm, or about 50 cm. For example, the width (W₃) of the solid state disk battery cell 700 can be about 0.1 mm to about 50 cm, about 0.1 mm to about 5 cm, or about 0.5 mm to about 1 cm.

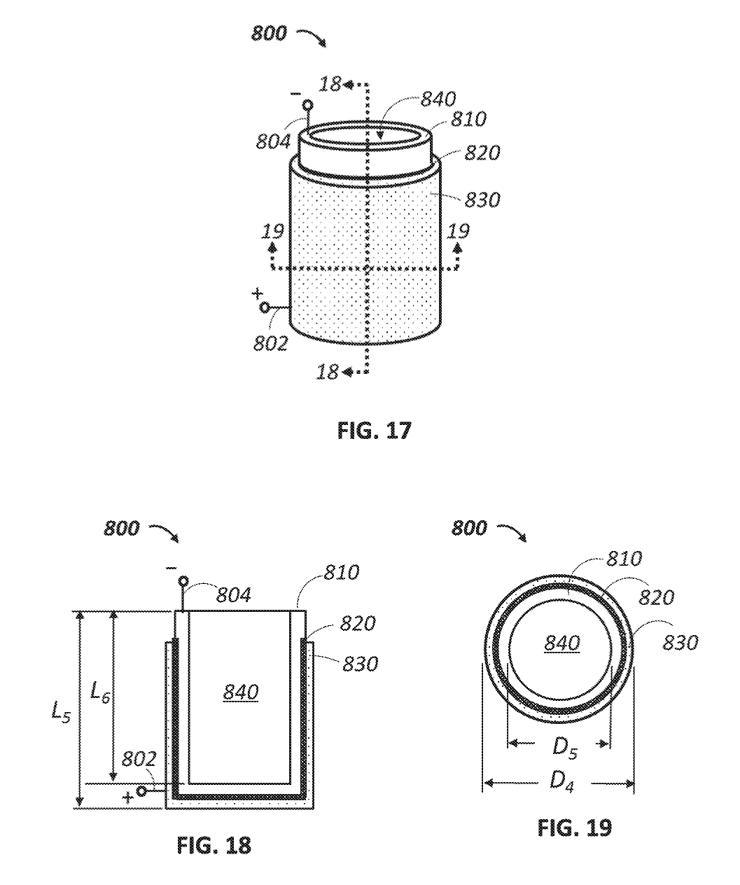

FIG. 17 depicts a sectional view of an illustrative solid state container battery cell 800, according to one or more embodiments. FIG. 18 depicts a sectional view of the solid state container battery cell 800 along line 18-18 in FIG. 17 and FIG. 19 depicts a sectional view of the solid state container battery cell 800 along line 19-19 in FIG. 17. The solid state container battery cell 800 can include one or more electrodes 810, one or more solid state ion conductors 820, one or more secondary solid state conductors (not shown), and one or more counter electrodes 830. The solid state ion conductor 820 can be disposed at least partially between the electrode 810 and the counter electrode 830. The solid state ion conductor 820 can be continuously or discontinuously disposed on one or more portions of the electrode 810. If the solid state battery 850 includes the secondary solid state conductor, then the secondary solid state conductor can be disposed at least partially between the solid state ion conductor 820 and the counter electrode 830.

The container battery 800 can include one or more cavities 840 at least partially defined by, at least partially contained within, or otherwise at least partially defined by the electrode 810. In one example, the electrode 810 can have a cylindrical geometry and the cavity 840 can have a smaller cylindrical geometry formed within the electrode 810. The container battery 800 can also include one or more cathodes 802 and one or more anodes 804. The cathode 802 can be connected to any portion of and/or in electrical communication with the counter electrode 830 and the anode 804 can be connected to any portion of and/or in electrical communication with the electrode 810. The cathode 802 and the anode 804 can each independently include one or more wires, one or more buses, one or more electrically conductive materials, as discussed and described herein, or any combination thereof.

In some embodiments, the solid state ion conductor 820 can be disposed on or otherwise formed on one or more first portions of the electrode 810, while one or more second portions of the electrode 810 can be free of the solid state ion conductor 820. For example, the solid state ion conductor 820 can be disposed on a portion of the outer surface of the electrode 810 and the remaining portioning of the outer surface and the inner surface of the electrode 810 can be free of the solid state ion conductor 820, as depicted in FIGS. 17-19. Also, the counter electrode 830 can be disposed on or otherwise formed on one or more first portions of the solid state ion conductor 820, while one or more second portions of the solid state ion conductor 820 can be free of the counter electrode 830. For example, the counter electrode 830 can be disposed on a portion of the outer surface of the solid state ion conductor 820 and the remaining portioning of the outer surface of the solid state ion conductor 820 can be free of the counter electrode 830.

The length (L₅) of the container battery 800 can be about 3 mm, about 10 mm, or about 20 mm to about 3 cm, about 10 cm, or about 200 cm. For example, the length (L₅) of the container battery 800 can be about 3 mm to about 200 cm, about 3 mm to about 10 cm, or about 3 mm to about 3 cm. The length (L₆) of the cavity 840 can be about 3 mm, about 8 mm, or about 18 mm to about 3 cm, about 10 cm, or about 200 cm. For example, the length (L₆) of the cavity 840 can be about 3 mm to about 200 cm, about 3 mm to about 10 cm, or about 3 mm to about 3 cm.

The diameter (D₄) of the container battery 800 can be about 1 mm, about 2 mm, about 4 mm, or about 8 mm to about 2 cm, about 4 cm, or about 100 cm. For example, the diameter (D₄) of the container battery 800 can be about 1 mm to about 100 cm, about 1 mm to about 10 cm, or about 1 mm to about 2 cm. The diameter (D₅) of the cavity 840 can be about 1 mm, about 4 mm, or about 8 mm to about 2 cm, about 4 cm, or about 100 cm. For example, the diameter (D₅) of the cavity 840 can be about 1 mm to about 100 cm, about 1 mm to about 10 cm, or about 1 mm to about 2 cm.

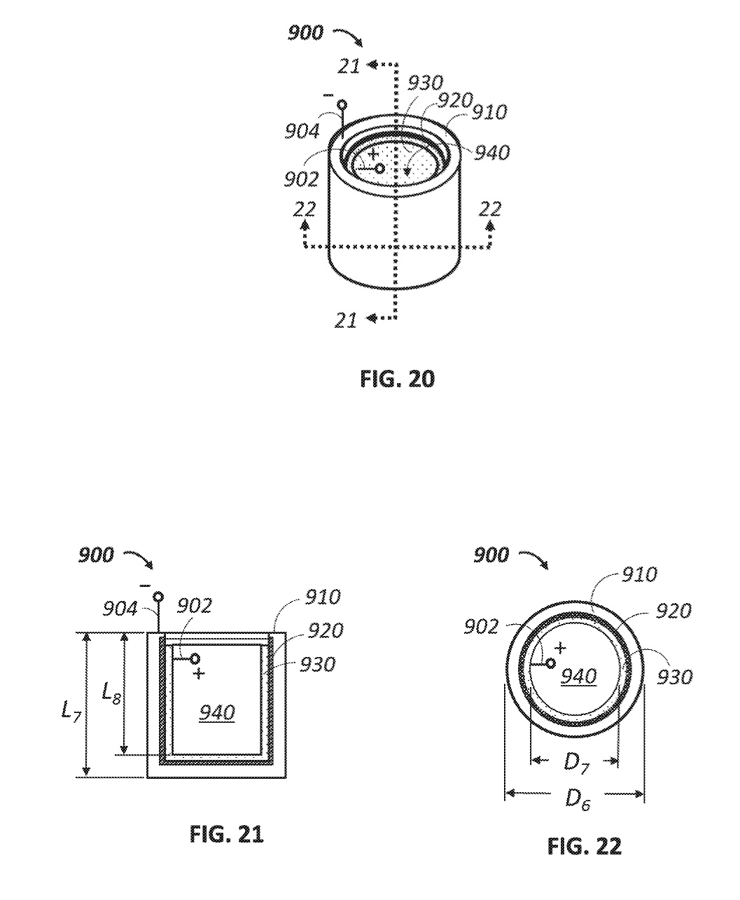

FIG. 20 depicts a sectional view of an illustrative solid state container battery cell 900, according to one or more embodiments. FIG. 21 depicts a sectional view of the solid state container battery cell 900 along line 21-21 in FIG. 20 and FIG. 22 depicts a sectional view of the solid state container battery cell 900 along line 22-22 in FIG. 20. The solid state container battery cell 900 can include one or more electrodes 910, one or more solid state ion conductors 920, one or more secondary solid state conductors (not shown), and one or more counter electrodes 930. The solid state ion conductor 920 can be disposed at least partially between the electrode 910 and the counter electrode 930. The solid state ion conductor 920 can be continuously or discontinuously disposed on one or more portions of the electrode 910. If the solid state battery 950 includes the secondary solid state conductor, then the secondary solid state conductor can be disposed at least partially between the solid state ion conductor 920 and the counter electrode 930.

The container battery 900 can include one or more cavities 940 at least partially defined by, at least partially contained within, or otherwise at least partially defined by the counter electrode 930. In one example, the counter electrode 930 can have a cylindrical geometry and the cavity 940 can have a smaller cylindrical geometry formed within the counter electrode 930. The container battery 900 can also include one or more cathodes 902 and one or more anodes 904. The cathode 902 can be connected to any portion of and/or in electrical communication with the counter electrode 930 and the anode 904 can be connected to any portion of and/or in electrical communication with the electrode 910. The cathode 902 and the anode 904 can each independently include one or more wires, one or more buses, one or more electrically conductive materials, as discussed and described herein, or any combination thereof.

In some embodiments, the solid state ion conductor 920 can be disposed on or otherwise formed on one or more first portions of the electrode 910, while one or more second portions of the electrode 910 can be free of the solid state ion conductor 920. For example, the solid state ion conductor 920 can be disposed on a first portion of the inner surface of the electrode 910 and the remaining portion or second portion of the inner surface and the outer surface of the electrode 910 can be free of the solid state ion conductor 920, as depicted in FIGS. 20-22. Also, the counter electrode 930 can be disposed on or otherwise formed on one or more first portions of the solid state ion conductor 920, while one or more second portions of the solid state ion conductor 920 can be free of the counter electrode 930. For example, the counter electrode 930 can be disposed on a portion of the inner surface of the solid state ion conductor 920 and the remaining portioning of the inner surface of the solid state ion conductor 920 can be free of the counter electrode 930.

The length (L₇) of the container battery 900 can be about 3 mm, about 10 mm, or about 20 mm to about 3 cm, about 10 cm, or about 200 cm. For example, the length (L₇) of the container battery 900 can be about 3 mm to about 200 cm, about 3 mm to about 10 cm, or about 3 mm to about 3 cm. The length (L₈) of the cavity 940 can be about 3 mm, about 8 mm, or about 18 mm to about 3 cm, about 10 cm, or about 200 cm. For example, the length (L₈) of the cavity 940 can be about 3 mm to about 200 cm, about 3 mm to about 10 cm, or about 3 mm to about 3 cm.

The diameter (D₆) of the container battery 900 can be about 1 mm, about 2 mm, about 4 mm, or about 8 mm to about 2 cm, about 4 cm, or about 100 cm. For example, the diameter (D₆) of the container battery 900 can be about 1 mm to about 100 cm, about 1 mm to about 10 cm, or about 1 mm to about 2 cm. The diameter (D₇) of the cavity 940 can be about 1 mm, about 4 mm, or about 8 mm to about 2 cm, about 4 cm, or about 100 cm. For example, the diameter (D₇) of the cavity 940 can be about 1 mm to about 100 cm, about 1 mm to about 10 cm, or about 1 mm to about 2 cm.

The electrodes 810 and/or 910 can be or include one or more magnesium-containing materials, the solid state ion conductors 820 and/or 920 can be or include one or more ion conductive materials, and the counter electrodes 830 and/or 930 can be or include one or more electrically conductive materials and can also be or include one or more ion conductive substances. In one or more embodiments, the electrodes 810 and/or 910 can include the same magnesium-containing materials as discussed and described above for the electrodes 110, 210, 310, and/or 410; the solid state ion conductors 820 and/or 920 can be or include one or more ion conductive materials as discussed and described above for the solid state ion conductors 120, 220, 320, and/or 420; and the counter electrodes 830 and/or 930 can be or include one or more electrically conductive materials and can also be or include one or more ion conductive substances as discussed and described above for the counter electrodes 130, 230, 330, and/or 430. In some examples, the magnesium-containing material contained in the electrodes 810 and/or 910 can be or include at least 90 at % of magnesium, the ion conductive material contained in the solid state ion conductors 820 and/or 920 can be or include one or more magnesium compounds, and the electrically conductive material contained in the counter electrodes 830 and/or 930 can be or include graphite and the ion conductive substance contained in the counter electrodes 830 and/or 930 can be or include one or more hydrates.

The magnesium-containing substrate used to produce the electrodes 810 and/or 910 and the solid state ion conductors 820 and/or 920 can be one or more magnesium-containing containers or vessels. In other examples, the magnesium-containing substrate used to produce the electrodes 810 and/or 910 and the solid state ion conductors 820 and/or 920 can be one or more pipes or one or more conduits that can be capped or otherwise closed on one end by one or more end caps or one or more plugs.

In some embodiments, the container battery 800 can include one or more cavities 840 at least partially defined by the electrode 810 and the container battery 900 can include one or more cavities 940 at least partially defined by the counter electrode 930. The container batteries 800 and/or 900 can store or contain one or more substances in the cavities 840 and/or 940 and at a predetermined time, can release or discharge the substance from the cavities 840 and/or 940. Illustrative substances that can be contained within the cavities 840 and/or 940 can be or include, but are not limited to, one or more of: a pharmaceutically active substance, a medicinal composition, a nutraceutical composition, a food, a dye, a perfume, a cosmetic composition, a detergent, a herbicide, a pesticide, a propellant, an explosive, or any mixture thereof.

In other embodiments, the container batteries 800 and/or 900 can store or contain one or more detectors, one or more sensors, one or more circuit boards, one or more processors, one or more signal or communication receiver and/or transmitter, or any combination thereof in the cavities 840 and/or 940. At a predetermined time, the container batteries 800 and/or 900 can be configured to open and expose the cavities 840 and/or 940 and to receive one or more substances in the cavities 840 and/or 940. The detector or sensor contained therein can be exposed to the one or more substances and can emit a signal from the container batteries 800 and/or 900.

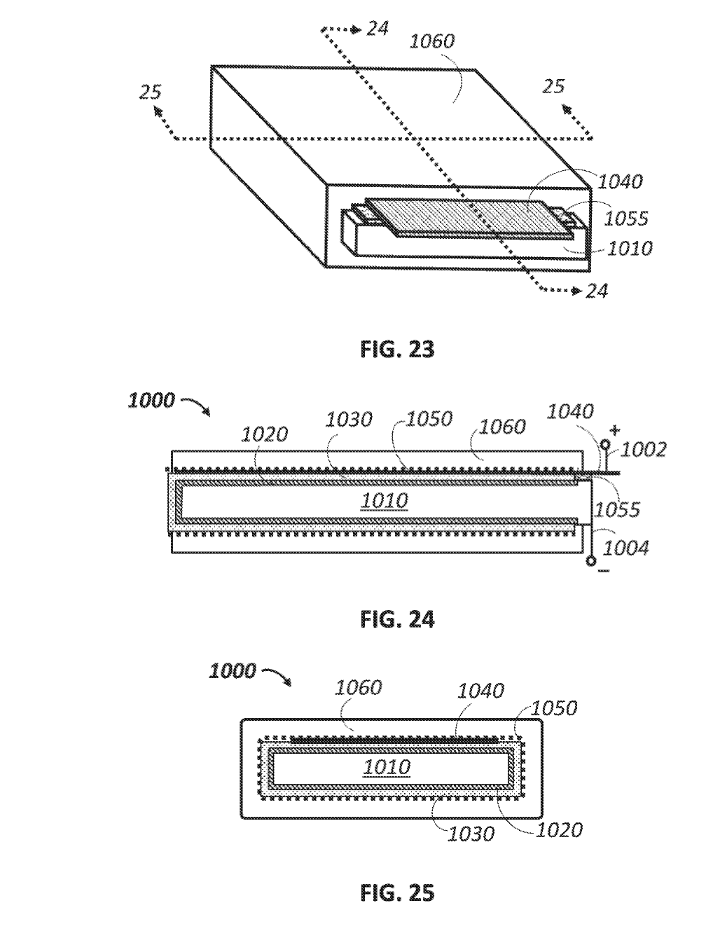

FIG. 23 depicts a perspective view of an illustrative solid state battery 1000, according to one or more embodiments. FIG. 24 depicts a sectional view of the solid state battery 1000 along line 24-24 in FIG. 23 and FIG. 25 depicts a sectional view of the solid state battery 1000 along line 25-25 in FIG. 23. The solid state battery 1000 can include one or more electrodes 1010, one or more solid state ion conductors 1020, one or more counter electrodes 1030, one or more current collectors 1040, one or more liquid retaining liners 1050, and one or more enclosures 1060. The solid state ion conductor 1020 can be disposed at least partially between the electrode 1010 and the counter electrode 1030. For example, the solid state ion conductor 1020 can be disposed on and at least partially over the electrode 1010 and the counter electrode 1030 can be disposed on the solid state ion conductor 1020. The current collector 1040 can be disposed on and at least partially over and in electrical communication with the counter electrode 1030. The liquid retaining liner 1050 can be disposed on and at least partially over the current collector 1040 and the enclosure 1060 can be disposed on and at least partially over the liquid retaining liner 1050.

The solid state battery 1000 can also include one or more cathodes 1002 and one or more anodes 1004, as depicted in FIG. 24. The cathode 1002 can be connected to any portion of and/or in electrical communication with the current collector 1040 and/or the counter electrode 1030 and the anode 1004 can be connected to any portion of and/or in electrical communication with the electrode 1010. The cathode 1002 and the anode 1004 can each independently include one or more wires, one or more buses, one or more electrically conductive materials, as discussed and described herein, or any combination thereof.

The solid state battery 1000 can also include one or more electrical insulators 1055. The electrical insulator 1055 can be disposed at least partially between and electrically insulating the electrode 1010 and/or the solid state ion conductor 1020 from the current collector 1040. The electrical insulator 1055 can include one or more electrically insulating materials, such as, but not limited to, one or more of: a heat shrink material, a wrapping fabric containing a liquid-proofing material, a wrapping paper containing a liquid-proofing material, or any combination thereof.

The electrode 1010 can be or include one or more magnesium-containing materials, the solid state ion conductor 1020 can be or include one or more ion conductive materials, and the counter electrode 1030 can be or include one or more electrically conductive materials and can also be or include one or more ion conductive substances. In one or more embodiments, the electrode 1010 can include the same magnesium-containing materials as discussed and described above for the electrodes 110, 210, 310, and/or 410; the solid state ion conductor 1020 can be or include one or more ion conductive materials as discussed and described above for the solid state ion conductors 120, 220, 320, and/or 420; and the counter electrode 1030 can be or include one or more electrically conductive materials and can also be or include one or more ion conductive substances as discussed and described above for the counter electrodes 130, 230, 330, and/or 430. In some examples, the magnesium-containing material contained in the electrode 1010 can be or include at least 90 at % of magnesium, the ion conductive material contained in the solid state ion conductor 1020 can be or include one or more magnesium compounds, and the electrically conductive material contained in the counter electrode 1030 can be or include graphite and the ion conductive substance contained in the counter electrode 1030 can be or include one or more hydrates.

The current collector 1040 can be coupled to and in electrical communication with the counter electrode 130. The current collector 1040 can include one or more metals. Illustrative metals contained in the current collector 1040 can be or include, but are not limited to, copper, silver, gold, nickel, aluminum, iron, chromium, steel, stainless steel, brass, bronze, alloys thereof, or any combination thereof. The current collector 1040 can include, but is not limited to, one or more: conductive meshes, conductive tapes, conductive fabrics, conductive papers, or any combination thereof. For example, the current collector 1040 can include a copper-containing mesh, a brass-containing mesh, a steel-containing mesh, an aluminum-containing mesh, other metal-containing meshes, or any combination thereof. In other examples, the current collector 1040 can include a copper-containing tape, an aluminum-containing tape, a metal-coated polyester conductive fabric comprising copper or nickel, a conductive carbon paper, or any combination thereof. In some embodiments, the current collector 1040 can be adhered to the counter electrode 1030 by one or more conductive adhesives disposed at least partially between the current collector 1040 and the counter electrode 1030. In other embodiments, the current collector 1040 can be adhered to the counter electrode 1030 by an adhesion force derived from compressing or pressing the current collector 1040 and the counter electrode 1030 together.

The enclosure 1060 can at least partially surround, cover, or otherwise encompass the electrode 1010, the solid state ion conductor 1020, the counter electrode 1030, the current collector 1040, and the liquid retaining liner 1050, as depicted in FIGS. 24 and 25. The enclosure 1060 can include one or more electrically insulating materials. Illustrative electrically insulating materials contained in the enclosure 1060 can be or include, but are not limited to, one or more of: a heat shrink tubing, a heat shrink wrap, a thermal laminating foil, a pressure laminating foil, a wrapping fabric containing a liquid-proofing material, a wrapping paper containing a liquid-proofing material, or any combination thereof.

In some examples, the solid state battery cells 100, 200, 300, 400, and/or 700 and the solid state battery 1000 can have a thickness of about 0.01 mm to less than 1 mm and can have a length by width surface area of about 0.1 cm² to less than 5 cm². In some examples, the solid state battery cells 100, 200, 300, 400, and/or 700 and the solid state battery 1000 can have a thickness of about 0.01 mm to less than 0.5 mm and can have a length by width surface area of about 0.1 cm² to less than 1 cm².

The solid state battery cells 100, 200, 300, 400, and/or 700 and the solid state batteries 550, 650, 800, 900, and/or 1000 can produce or otherwise generate a voltage of about 0.5 V, about 0.8 V, about 1 V, about 1.2 V, or about 1.4 V to about 1.5 V, about 1.8 V, about 2 V, about 2.2 V, about 2.5 V, about 2.8 V, about 3 V, about 3.2 V, or greater. For example, the solid state battery cells 100, 200, 300, 400, and/or 700 and the solid state batteries 550, 650, 800, 900, and/or 1000 can produce or otherwise generate a voltage of about 0.5 V to about 3.2 V, about 0.8 V to about 2.7 V, about 1 V to about 2.2 V, greater than 1 V to less than 2.2 V, about 1.2 V to about 2.2 V, or about 1.4 V to about 1.9 V. In one or more embodiments, a printed circuit board (PCB) can include one or more of the solid state battery cells 100, 200, 300, 400, and/or 700 and the solid state batteries 550, 650, 800, 900, and/or 1000, as discussed and described herein.

In one or more embodiments, a method for making a solid state battery cell can include combining a magnesium-containing substrate, a reagent solution, and graphite to produce a mixture, where the magnesium-containing substrate can be or include at least 90 at % of magnesium. The method can include reacting a portion of the magnesium-containing substrate and the reagent solution in the mixture to produce a solid state ion conductor disposed on an electrode and to produce a counter electrode disposed on the solid state ion conductor. The solid state ion conductor can be or include one or more ion conductive materials derived from the reacted portion of the magnesium-containing substrate. The electrode can include the unreacted portion of the magnesium-containing substrate and the counter electrode can include at least a portion of the graphite derived from the mixture. The solid state ion conductor can be disposed at least partially between the electrode and the counter electrode. The counter electrode and the solid state ion conductor can have a combined thickness of about 1 μm to less than 1 mm.

In other embodiments, a method for making a solid state battery cell can include combining a magnesium-containing substrate and a reagent solution to produce a mixture, where the magnesium-containing substrate can be or include at least 90 at % of magnesium. The method can include reacting a portion of the magnesium-containing substrate and the reagent solution in the mixture to produce a solid state ion conductor disposed on an electrode, wherein the solid state ion conductor comprises an ion conductive material derived from the reacted portion of the magnesium-containing substrate and the electrode comprises the unreacted portion of the magnesium-containing substrate. The method can include forming a counter electrode that can include an electrically conductive material, where the solid state ion conductor can be disposed at least partially between the electrode and the counter electrode, and the counter electrode and the solid state ion conductor can have a combined thickness of about 1 μm to less than 1 mm. The electrode can include at least 90 at % of magnesium and the ion conductive material can be or include a magnesium compound. The magnesium-containing substrate can be or include a wire, a rod, a foil, a sheet, a plate, a film, a disk, a strip, a container, a conduit, a pipe, an end cap, a plug, or any combination thereof.

The method can also include flowing an electrical current through the reagent solution and into the magnesium-containing substrate when reacting the portion of the magnesium-containing substrate and the reagent solution to produce the ion conductive material. The reagent solution can include one or more electrolytes. The magnesium-containing substrate can be connected to an electrical terminal of a power supply, either negative or positive electrical current with a direct current (DC) or an alternating current (AC), referencing with another terminal of the power supply contacting the reagent solution. The electrical current can be passed or flowed between the terminals and through the reagent solution and the magnesium-containing substrate. For example, the electrical current can be a DC and can flow or otherwise pass through the reagent solution and the magnesium-containing substrate at a desired voltage and for a desired period of time. For example, the electrical current can have a voltage of about 1 V, about 1.5 V, about 2 V, about 3 V, about 4 V, or about 5 V to about 6 V, about 7 V, about 8 V, about 9 V, about 10 V, about 12 V, or about 15 V and for a period of about 5 seconds, about 10 seconds, or about 15 seconds to about 1 minute, about 2 minutes, or about 5 minutes.

The method can also include combining graphite and one or more substances to produce a mixture containing the graphite and the substance. In some examples, the mixture can include the graphite and one or more adhesives. In other examples, the mixture can include the graphite and one or more ionic compounds and/or one or more salts. The ionic compound or the salt can include one or more cations, one or more anions, one or more hydrates, or any mixture thereof. The cation can be or include, but is not limited to, cations of copper, iron, zinc, tin, aluminum, manganese, titanium, sodium, potassium, cesium, magnesium, calcium, vanadium, beryllium, cerium, or any mixture thereof. For example, the cation can be or include, Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof. The anion can be or include, but is not limited to, perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

The method can include applying the mixture containing the graphite and the substance over at least a portion of the solid state ion conductor to form the counter electrode. The method can also include heating the mixture containing the graphite and the substance to a temperature of greater than 60° C., about 100° C., about 150° C., or about 200° C. to about 250° C., about 300° C., about 350° C., about 375° C., or less than 400° C. to form the counter electrode. The substance can be or include, but is not limited to, one or more adhesives. Illustrative adhesives can be or include, but are not limited to, one or more of: a polymeric material, and wherein the polymeric material can be or include, but is not limited to, a poly(acrylic acid), a polyacrylate, a poly(methyl acrylate), a poly(vinyl acetate), an alkyl derivative thereof, a copolymer thereof, a salt thereof, or any mixture thereof. The adhesive can include a plurality of particles and one or more solvents. In some examples, the plurality of particles can be or include the polymeric material and the plurality of particles can have an average particle size of less than 1 μm.

The method can also include forming a mask on at least a portion of the unreacted portion of the magnesium-containing substrate prior to combining the magnesium-containing substrate and the reagent solution. The reagent solution can include, but is not limited to, copper oxide, iron oxide, manganese oxide, tin oxide, vanadium oxide, cerium oxide, ammonium perchlorate, potassium perchlorate, sodium perchlorate, ammonium chloride, aluminum chloride, calcium chloride, cesium chloride, magnesium chloride, potassium chloride, sodium chloride, magnesium sulfate, copper sulfate, aluminum silicate, potassium aluminum silicate, cobalt chloride, magnesium acetate, iron cyanide, magnesium hydroxide, calcium hydroxide, sodium hydroxide, lithium hydroxide, cesium hydroxide, aluminum hydroxide, ammonium hydroxide, sodium calcium aluminum magnesium silicate hydroxide, hydrogen chloride, hydrogen sulfate, hydrogen phosphate, hydrates thereof, isomers thereof, or any combination or mixture thereof.

The method can also include forming one or more layers containing one or more hydrated materials on the solid state ion conductor prior to forming the counter electrode. The layer containing the hydrated material can be disposed at least partially between the solid state ion conductor and the counter electrode.

A magnesium-containing substrate dipped into, exposed to, or otherwise combined with the reagent solution in one or more containers. The magnesium-containing substrate can be or include, but is not limited to, a wire, a rod, a sheet, a strip, a film, a disk, a container, a conduit, a pipe, an end cap, or a plug and can include one or more masks or can be free of a mask. The solution can include water and can include one or more other solvents. Illustrative solvents can be or include, but are not limited to, water, one or more alcohols, one or more ethers, one or more other type of organic solvents, or any mixture thereof. The reagent solution can include one or more precursors that react with magnesium. For example, the reagent solution can include a mixture of compounds with different metal cations in order to produce one or more layers of the solid state ion conductor that has multiple metal cations.

The reagent solution can include one or more acids, one or more peroxides, or a mixture thereof. Illustrative acids and peroxides can be or include, but are not limited to, acetic acid, acrylic acid, hydrochloric acid, hydrogen peroxide, phosphoric acid, sulfuric acid, salts thereof, or any mixture thereof. The reagent solution can include the acid in an amount of about 0.01 g, about 0.1 g, or about 1 g to about 10 g, about 100 g, or about 1,000 g per 100 g of water and can include the peroxide in an amount of about 0.1 g, about 1 g, or about 5 g to about 10 g, about 20 g, or about 50 g per 100 g of water.

The reagent solution can include, but is not limited to, one or more bases. Illustrative bases can be or include, but are not limited to, ammonium hydroxide, lithium hydroxide, sodium hydroxide, potassium hydroxide, calcium hydroxide, magnesium hydroxide, aluminum hydroxide, or any mixture thereof. The reagent solution can include the base in an amount of about 0.01 g, about 0.1 g, or about 1 g to about 10 g, about 50 g, or about 100 g per 100 g of water.

The reagent solution can include, but is not limited to, one or more ionic compounds and/or one or more salts. Illustrative ionic compounds and salts can include, but is not limited to, one or more of: perchlorates, one or more sulfates, one or more chlorides, potassium permanganate (KMnO₄), magnesium citrate (C₆H₆MgO₇), magnesium stearate (Mg(C₁₈H₃₅O₂)₂), or any mixture thereof. Illustrative perchlorates can be or include, but are not limited to, ammonium perchlorate, lithium perchlorate, sodium perchlorate, potassium perchlorate, or any mixture thereof. Illustrative sulfates can be or include, but are not limited to, ammonium sulfate, magnesium sulfate, aluminum sulfate, copper sulfate, potassium aluminum sulfate (KAl(SO₄)₂), or any mixture thereof. Illustrative chlorides can be or include, but are not limited to, aluminum chloride, cesium chloride, calcium chloride, magnesium chloride, lithium chloride, sodium chloride, potassium chloride, or any mixture thereof. The reagent solution can include each ionic compound or salt independently in an amount of about 0.01 g, about 0.1 g, or about 1 g to about 10 g, about 50 g, about 100 g, or about 500 g per 100 g of water.

The reagent solution can also include, but is not limited to, one or more metal oxides, one or more metal cyanides, or a mixture thereof. Illustrative metal oxides and metal cyanides can be or include, but are not limited to, aluminum silicate (Al₂SiO₅), cerium oxide, copper oxide, iron oxide, manganese oxide, tin oxide, iron cyanide (e.g., Fe₇(CN)₁₈), or any mixture thereof. The reagent solution can include the metal oxide in an amount of about 0.01 g, about 0.1 g, or about 1 g to about 10 g, about 50 g, about 100 g, or about 500 g per 100 g of water and can include the metal cyanide in an amount of about 0.01 g, about 0.1 g, or about 1 g to about 10 g, about 50 g, about 100 g, or about 500 g per 100 g of water.

One or more reagents and the magnesium-containing substrate can be reacted together to produce the solid state ion conductor and the electrode. The solid state ion conductor can be formed directly on the electrode by converting at least a portion of the magnesium-containing substrate to produce the ion conductive material containing one or more magnesium compounds disposed on the remaining magnesium-containing substrate. The color of the ion conductive material formed as at least a portion of the solid state ion conductor can be related, at least in part, to the chemical composition, thickness, and/or quality of the film, and can be used as an endpoint of the reaction.

After converting a portion of the magnesium in the magnesium-containing substrate to the ion conductive material, the remaining magnesium-containing substrate with the ion conductive material disposed thereon can be moved from the container. A cleaning and annealing process can be used to remove at least a portion of any undesired residues and to make a film having a desired stability and a desired compound or crystalline structure, and can be one or more solid state ion conductors. The annealing can be carried out in air, in vacuum, or under a pressure greater than atmospheric pressure in a relatively inert gas (e.g., argon or nitrogen) with or without other additive gas such as water vapor. Additional films can be coated with the one or more compositions at the same or different electrical power setting as well as cleaning and annealing process. After forming the solid state ion conductor, a film with an electrically conductive material can be coated on the top of the solid state ion conductor as a counter electrode. The coating process can be a process using a liquid or paste that has or includes graphite as an electrically conductive material. The liquid or paste can be water-based. The liquid or paste can include one or more non-volatile substances or one or more substances dissolved or mixed in one or more the liquids. For example, the non-volatile additive can be a conductive polymer such as PEDOT:SST. The non-volatile additive can be or include one or more metal oxide, one or more hydroxides, one or more salts, or any mixture thereof. Therefore, the counter electrode formed can often be a composite electrode including at least one electrically conductive material and one ion conductor. The coating process can be repeated two or more times, and the ratio of the electrically conductive material to the non-volatile additives in each coating can be the same or different with respect to one another. For example, the ratio of the electrically conductive material to the non-volatile additives in each coating can be about 10% to about 95% with respect to one another. In some examples, the ratio of the top layer can be greater than the ratio of the bottom layer. The chemical composition of additives in each coating can also be the same or different with respect to one another. To form a counter electrode with a layered structure, coating with different ratio and different chemical composition can be used. The counter electrode can be coated repeatedly with two or more different layers several times to form a repeated layer structure or coated all layers with different ratios or compositions or both to form a non-repeated layer structure such as a grading composition structure. An adhesive substance, such as a water-based adhesive of acrylate copolymer or aliphatic rubbery synthetic polymer in form of particles, can be added into the paint or paste to promote the strength and adhesion of the coating.

After the counter electrode is formed, the battery cell can be a functional cell in room air without any protection layer. One or more protection layers with or without an electrical current collector can be added for better durability, performance stability, connection flexibility, or other purposes, for example. In some examples, the protection layer can be air-tight and/or moisture-tight. In other examples, the protection layer can be permeable to air and/or water. The protection layer can be partially or completely wrapped or enclosed about the battery cell or two or more battery cells. The protection layer can be or include, but is not limited to, one or more plastic materials, one or more fabric materials, one or more paper materials, or any combination thereof. The current collector can be or include metal tape, mesh, wire, or combinations thereof attached to the counter electrode with an adhesive or a compression force from the protection layer. One or more liners can be used before putting a protection layer on the battery cell. The liner can be or include one or more fabric materials, one or more paper materials, one or more moisture retainer substances, or any combination thereof. For example, the liner can include fabric or paper entrained therein (such as by soaking) or coated thereon one or more moisture retainer substances. The liner can be a moisture barrier and eliminate or greatly reduce the amount of water entering or exiting the battery cell.

In one or more embodiments, solid state battery cells, such as, but not limited to, the solid state battery cells 200 and 400 (FIGS. 4-6 and 10-12, respectively), can also be made using a process that can include one or more converting processes and then one or more coating processes. In the converting process, the reagent solution can have one or more reactive species that can react with the magnesium-containing substrate. One or more other non-volatile materials can be mixed, suspended, settled, or dissolved in the reagent solution. The non-volatile material can be or include one or more nonconductive materials, one or more conductive materials, or a mixture thereof. The reagent solution can be or include one or more liquids and can also include one or more solids and/or one or more gases mixed with the one or more liquids. In other embodiments, the reagent solution can be or include, but is not limited to, one or more pastes, one or more paints, one or more inks (e.g., printing compounds), or any mixture thereof. For example, the reagent solution can be viscous enough to stay on the magnesium-containing substrate without the use of a container that can otherwise be used to hold the reagent solution on the one or more surfaces of magnesium-containing substrate.

The solid state ion conductor and the electrode can be produced by reacting the magnesium-containing substrate and the reagent solution with or without an electrical current flowing therethrough. The reaction can be or include a chemical redox reaction, an electro redox reaction, and/or an electrochemical redox reaction. In addition, the process can be repeated to make layered structures with a variety of compositions or thicker structures of the same composition. In some examples, the magnesium-containing substrate can be connected to an electrical terminal from a power supply with a DC or AC voltage referencing another electrical terminal that contacts the reagent solution. During the process, the reactive species in the reagent solution react with the magnesium and convert a portion of the magnesium from the surface to a solid state ion conductor, while the non-volatile material holding on the magnesium-containing substrate surface can form one or more additional layers and the solvent can evaporate. In some examples, if the non-volatile material is not electrically conductive or can be further enhanced with additional electrically conductive material, one or more additional layers, films, or materials can be disposed or otherwise formed on the solid state ion conductor to produce one or more secondary solid state conductors 222 and 422, as shown in FIGS. 4-6 and FIGS. 10-12, respectively. In other examples, if the non-volatile materials are or include electrically conductive materials, the additional film formed can serve as counter electrodes 130 and 330 shown in FIGS. 1-3 and FIGS. 4-6, respectively.

In one or more examples, the electrode and the solid state ion conductor of the solid state battery cell can be produced from a magnesium-containing substrate. One or more reagents and the magnesium-containing substrate can be reacted together to produce the solid state ion conductor and the electrode. The solid state ion conductor can be formed directly on the electrode by converting at least a portion of the magnesium-containing substrate to produce the ion conductive material that can include one or more magnesium compounds. One or more masks can be used to keep one or more portions of the magnesium-containing substrate as a metal during the conversion process. One or more surfaces on the magnesium-containing substrate can be masked, blocked, or otherwise covered with the mask or one or more masking materials when exposed to the reagent.

In some examples, the magnesium-containing substrate can be a magnesium-containing wire or rod to produce the electrodes 110 and 210 and at least a portion of the solid state ion conductor 120, 220 for the solid state battery cells 100 and 200, as depicted in FIGS. 1-6. In other examples, the magnesium-containing substrate can be a magnesium-containing plate, strip, or film to produce the electrodes 310 and 410 and at least a portion of the solid state ion conductors 320 and 420 of the solid state battery cells 300 and 400, as depicted in FIGS. 7-12. In other examples, the magnesium-containing substrate can be a magnesium-containing disk, round plate, or round film to produce the electrode 710 and at least a portion of the solid state ion conductor 720 of the solid state disk battery cell 700, as depicted in FIGS. 15 and 16. In other examples, the magnesium-containing substrate can be a magnesium-containing vessel, container, or end capped conduit or pipe to produce the electrodes 810 and 910 and at least a portion of the solid state ion conductors 820 and 920 of the solid state container battery cells 800 and 900, as depicted in FIGS. 17-22.

In some examples, the ion conductive material contained in the solid state ion conductors 120 and 220 for the solid state battery cells 100 and 200, as depicted in FIGS. 1-6; the solid state ion conductors 320 and 420 of the solid state battery cells 300 and 400, as depicted in FIGS. 7-12; the solid state ion conductor 720 of the solid state disk battery cell 700, as depicted in FIGS. 15 and 16; and the solid state ion conductors 820 and 920 of the solid state container battery cells 800 and 900, as depicted in FIGS. 17-22, can be formed though a reaction taking place with exposed surfaces of the magnesium-containing substrates using one or more reagents. The one or more reagents can be contained in one or more reagent solutions that can be combined with or otherwise exposed to the magnesium-containing substrate. In one or more examples, the reagent solution can be or include one or more chloride-containing reagent solutions that can include about 0.01 g to about 10 g of magnesium chloride, about 0.01 g to about 10 g of calcium chloride, about 0.01 g to about 10 g of potassium chloride, about 0.01 g to about 10 g of aluminum chloride, about 0.01 g to about 10 g of sodium chloride, about 0.01 g to about 10 g of ammonium perchlorate, about 0.001 g to about 10 g of cesium chloride, optionally about 1 g to about 100 g of graphite powder, optionally about 0.1 g to about 100 g of poly(methyl acrylate), optionally about 1 g to about 100 g of hydrogen peroxide solution (about 3 volume percent (vol %) of H₂O₂ and about 97 vol % of water), and about 1 g to about 100 g of water.

In some examples, the ion conductive material and/or the solid state ion conductor can be formed by dipping or otherwise exposing the magnesium-containing substrate to one or more reagent solutions contained in a tank or vessel. As an option, a power supply can be electrically connected to the magnesium-containing substrate and the reagent solutions through two terminals, and a direct current under about 1 V to about 5 V can be flowed from the power supply through the reagent solution and the magnesium-containing substrate for about 5 seconds to about 5 minutes. The magnesium-containing substrate can be exposed to the reagent solution to form the solid state ion conductor, also referred to as a “dipping time”, for about 10 seconds to about 10 minutes. In other examples, the ion conductive material can be formed by painting or coating the magnesium-containing substrate with one or more reagent solutions with a brush or a spray coating. The ion conductive material can be deposited or otherwise formed once volatile solvents or other compound evaporate from the reagent solution.

In one or more examples, the ion conductive material and/or the solid state ion conductor layer can be exposed to one or more annealing processes. For example, the ion conductive material and/or the solid state ion conductor layer can be heated at a temperature of about 80° C. to about 400° C. in the air or under other gaseous environments (e.g., argon or nitrogen) for about 5 minutes to about 4 hours. The ion conductive material and/or the solid state ion conductor layer can be formed from one or more formation processes and/or one or more annealing processes. For example, two or more layers of the ion conductive material can be formed or otherwise deposited one after another. In some examples, the same reagent solution can be repeatedly used under the same or different process condition, or in other examples, the reagent solutions with the same reagents but different concentrations of the reagents in each process.

In other examples, two or more different reagent solutions in each process can be used to form two or more layers of the ion conductive material. For example, a reagent solution that can be used to form a second, third, or additional coating or layer of one or more ion conductive materials can include one or more oxide-containing compounds combined with the chloride-containing reagent solution discussed and described above. Illustrative oxide-containing compounds can be or include, but are not limited to, one or more metal oxides, one or more metal hydroxide, one or more metal silicates, or any mixture thereof. In some examples, the reagent solution can include the chloride-containing reagent solution and can also include about 0.01 g to about 10 g of magnesium oxide, about 0.01 g to about 10 g of aluminum oxide, about 0.01 g to about 10 g of aluminum silicate, about 0.01 g to about 10 g of calcium hydroxide, about 0.01 g to about 10 g of calcium silicate, about 0.01 g to about 10 g of copper oxide, about 0.01 g to about 10 g of iron oxide, and about 0.01 g to about 10 g of cerium oxide.

In some examples, the reagent solution for a second, third, or additional coating or layer of one or more ion conductive materials can be or include a sulfate-containing reagent solution, instead of chloride-containing reagent solution used in the first formation process. For example, the sulfate-containing reagent solution can include about 0.01 g to about 10 g of magnesium sulfate, about 0.01 g to about 10 g of aluminum sulfate, about 0.01 g to about 10 g of potassium sulfate, about 0.01 g to about 1 g of copper sulfate, about 0.01 g to about 1 g of iron sulfate, optionally about 1 g to about 100 g of graphite powder, optionally about 0.1 g to about 100 g of poly(methyl acrylate), optionally about 1 g to about 100 g of hydrogen peroxide solution (about 3 vol % of H₂O₂ and about 97 vol % of water), and about 1 g to about 100 g of water.

In some examples, multiple layer formation processes with a different reagent solutions can be used to form the secondary solid state conductors 222 and/or 422 on or over the solid state ion conductors 220 and/or 420 for making the solid state battery cells 200 and/or 400, as depicted in FIGS. 4-6 and FIGS. 10-12, respectively. For example, the solid state ion conductors 220 and/or 420 can be formed using the chloride-containing reagent solution and the secondary solid state conductors 222 and/or 422 can be formed using the sulfate-containing reagent solution. Alternatively, in other examples, the solid state ion conductors 220 and/or 420 can be formed using the sulfate-containing reagent solution and the secondary solid state conductors 222 and/or 422 can be formed using the chloride-containing reagent solution. In one or more examples, the multiple layer formation processes use the two different reagent solutions alternatively more than two times, and the solid state ion conductors 120, 220, 320, 420, 720, 820, and/or 920 formed using the multiple layer formation processes has multiple layers of different compositions.

One or more electrically conductive materials, and optionally one or more ion conductive materials or substances, can be coated or otherwise disposed on at least a portion of the solid state ion conductors 120, 220, 320, 420, 720, 820, and/or 920 and/or the secondary solid state conductors 232 and/or 432 to produce the counter electrodes 130, 230, 330, 430, 730, 830, and/or 930.

The counter electrodes 130, 230, 330, 430, 730, 830, and/or 930 can be formed, at least in part, by applying, coating, or dispersing one or more paints and/or one or more pastes that can include one or more electrical conductive materials. The paint or paste can be applied or coated by brush, spray coating, dipping, printing, or any combination thereof. In some examples, the paint or paste can include about 1 g to about 100 g of graphite, about 0.01 g to about 100 g of poly(methyl acrylate), and about 1 to about 100 g water. In some examples, the electrically conductive material mixed with ion conductive materials or substance can be coated in a form of a paint or paste. The paint or paste can include about 1 g to about 100 g of graphite powder, about 0.01 g to about 10 g of magnesium oxide, about 0.01 g to about 10 g of magnesium chloride, about 0.01 g to about 10 g of magnesium sulfate, about 0.01 g to about 10 g of aluminum chloride, about 0.01 g to about 10 g of aluminum sulfate, about 0.01 g to about 10 g of aluminum silicate, about 0.01 g to about 10 g of calcium hydroxide, about 0.01 g to about 10 g of calcium chloride, about 0.01 g to about 10 g of calcium silicate, about 0.01 g to about 10 g of copper oxide, about 0.01 g to about 10 g of iron oxide, about 0.01 g to about 10 g of cerium oxide, optionally about 0.1 g to about 100 g of poly(methyl acrylate), and about 1 g to about 100 g of water. The thickness of each coating can be about 0.2 μm to about 100 μm. The counter electrode layer can be formed through multiple coating processes with paints or pastes of the same composition or different compositions. In one or more examples, the counter electrode layer can be exposed to one or more annealing processes. For example, the counter electrode layer can be heated at a temperature of about 80° C. to about 400° C. in the air or under other gaseous environments (e.g., argon or nitrogen) for about 5 minutes to about 4 hours.

### EXAMPLES

In order to provide a better understanding of the foregoing discussion, the following non-limiting examples are offered. Although the examples can be directed to specific embodiments, they are not to be viewed as limiting the invention in any specific respect.

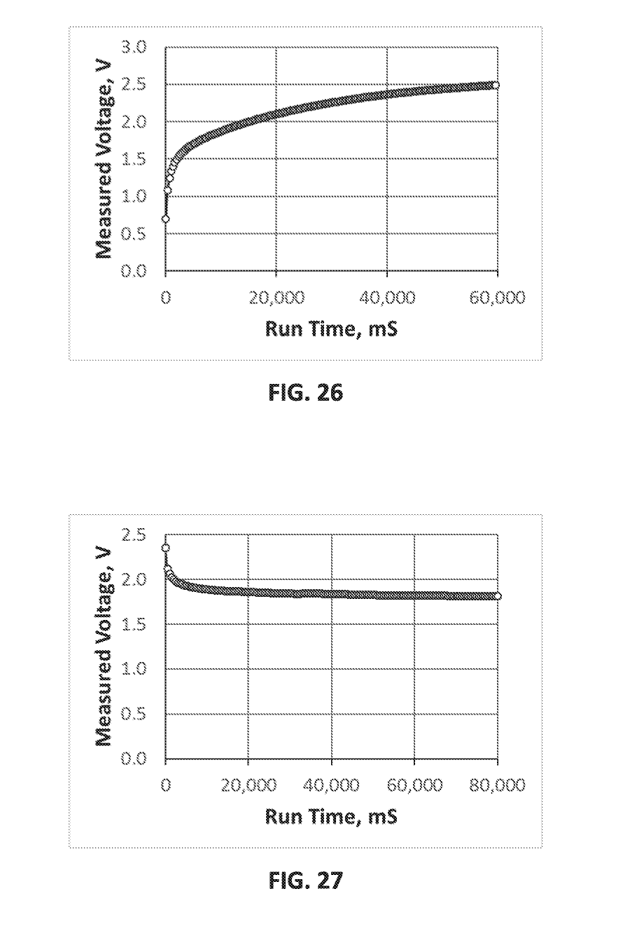

Multiple solid state battery cells were made using magnesium-containing sheets, magnesium-containing strips, and magnesium-containing wires as a source for the electrodes containing magnesium. A solid state battery cell was made from a magnesium-containing strip having the dimensions of about 20 mm×about 4 mm×about 0.3 mm. The magnesium-containing strip contained 99.98 at % of magnesium. The solid state battery cell that was measured to demonstrate its functionality had a structure similar to the structure of the solid state battery cell 200 depicted in FIGS. 4-6. FIGS. 26-29 show graphs of voltage responses for the solid state battery to different currents through the battery in a testing cycle. The open circuit voltage of the battery can be about 1.5 V.

FIG. 26 depicts a graph of measured voltage over time in a recharge mode for an illustrative solid state battery. As the first step of the cycle, a constant charging current (positive current) was forced through the battery to show voltage change of the battery with time. The battery in this step was in a recharge mode. Before starting the step, the battery was almost depleted to a voltage close to zero, such as about 0.1 V. During the charging in the step, the voltage increased quickly, and reached about 2.5 V.

FIG. 27 depicts a graph of measured voltage over time in a discharge mode for an illustrative solid state battery. As the second step of the cycle, a constant discharge current (negative current) was forced through the battery to show voltage change of the battery with time. The battery in this step was in a weak discharge mode. The discharge current was about two orders of magnitude lower than that in the first step. In this step, the current dropped and approaches to a voltage of about 1.8 V, which was higher than its open circuit voltage of about 1.5 V at the beginning of the testing cycle.

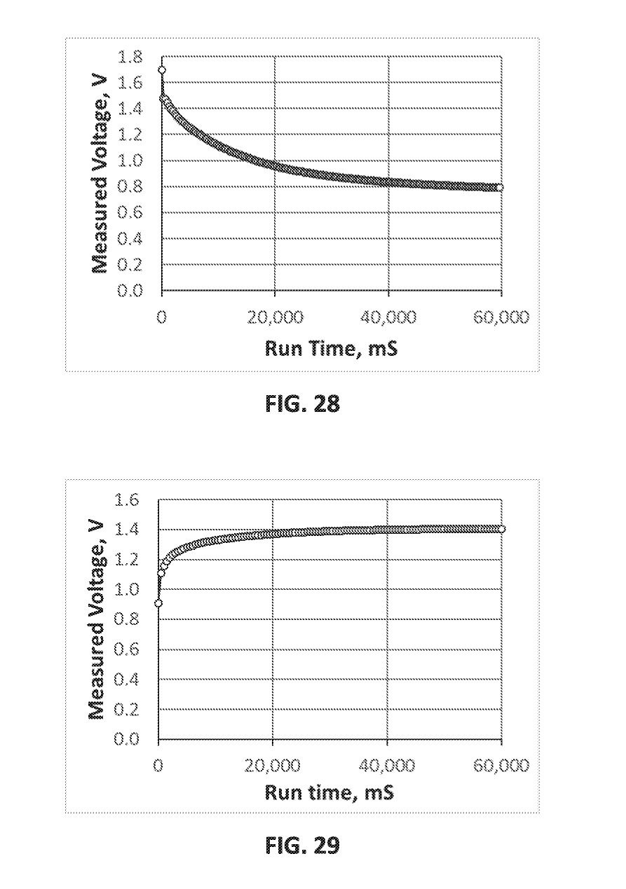

FIG. 28 depicts a graph of measured voltage over time in another discharge mode for an illustrative solid state battery. As the third step of the cycle, a higher discharging current (negative current) was forced through the battery to show the voltage change with time. The battery in this step was in a forced discharge mode. The discharge current in the step was as high as the current in first step but in an opposite direction. In this step, the voltage of the battery further dropped from about 1.8 V from the previous step to about 0.8 V.

FIG. 29 depicts a graph of measured voltage over time in a self-recovery mode for an illustrative solid state battery. As the last step of the cycle, a low constant discharge current (negative current) was forced through the battery to show the voltage change with time. The battery in this step was in a self-recovery mode. The current was the same as in the second step. In this step, the voltage of battery was recovered with a discharge current (negative current), and approaches to about 1.4 V, which was slightly less than its open circuit voltage of about 1.5 V at the beginning of the testing cycle.

Overall, the test indicated that the solid state ion conductor used in the battery can produce or sustain an electrical potential between the electrode and counter electrode, comparing to a zero potential when the film was a conductor or resistor. The battery formed with the solid state ion conductor also had function of recharging and self-recovery. In some experiments, several battery cells showed a decrease in current as air exposed to the battery cells was restricted. These results indicate that the battery cell functioned similar to a metal-air battery.

Embodiments of the present disclosure further relate to any one or more of the following paragraphs:

1. A solid state battery cell comprising a solid state ion conductor disposed between an electrode and a counter electrode, wherein: the electrode comprises at least 90 at % of magnesium, the counter electrode comprises an electrically conductive material, the solid state ion conductor comprises an ion conductive material, the ion conductive material comprises a magnesium compound, and the counter electrode and the solid state ion conductor have a combined thickness of about 1 μm to less than 1 mm.

2. A solid state battery cell comprising a solid state ion conductor disposed between an electrode and a counter electrode, wherein: the electrode comprises at least 90 at % of magnesium, the counter electrode comprises an electrically conductive material and an ion conductive substance, the solid state ion conductor comprises an ion conductive material, the ion conductive material comprises a hydrated material, and the counter electrode and the solid state ion conductor have a combined thickness of about 1 μm to less than 1 mm.

3. The solid state battery cell of paragraph 2, wherein each of the ion conductive substance and the ion conductive material independently comprises a hydrated material, and wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

4. A method for making a solid state battery cell, comprising: combining a magnesium-containing substrate, a reagent solution, and graphite to produce a mixture, wherein the magnesium-containing substrate comprises at least 90 at % of magnesium; and reacting a portion of the magnesium-containing substrate and the reagent solution in the mixture to produce a solid state ion conductor disposed on an electrode and to produce a counter electrode disposed on the solid state ion conductor, wherein the solid state ion conductor comprises an ion conductive material derived from the reacted portion of the magnesium-containing substrate, the reagent solution and the electrode comprises an unreacted portion of the magnesium-containing substrate, and the counter electrode comprises at least a portion of the graphite derived from the mixture, wherein the solid state ion conductor is disposed at least partially between the electrode and the counter electrode, and the counter electrode and the solid state ion conductor have a combined thickness of about 1 μm to less than 1 mm.

5. A method for making a solid state battery cell, comprising: combining a magnesium-containing substrate comprising at least 90 at % of magnesium and a reagent solution to produce a mixture; reacting a portion of the magnesium-containing substrate and the reagent solution in the mixture to produce a solid state ion conductor disposed on an electrode, wherein the solid state ion conductor comprises an ion conductive material derived from the reacted portion of the magnesium-containing substrate and the reagent solution and the electrode comprises an unreacted portion of the magnesium-containing substrate; and forming a counter electrode comprising an electrically conductive material over the solid state ion conductor, wherein the solid state ion conductor is at least partially disposed between the electrode and the counter electrode, and wherein the counter electrode and the solid state ion conductor have a combined thickness of about 1 μm to less than 1 mm.

6. The solid state battery cell or method according to any one of paragraphs 1-5, wherein the electrode and at least a portion of the solid state ion conductor are derived from the same magnesium-containing substrate.

7. The solid state battery cell or method according to paragraph 6, wherein the magnesium compound in the solid state ion conductor is produced from a first portion of the magnesium-containing substrate and the magnesium in the electrode is from a second portion of the magnesium-containing substrate.

8. The solid state battery cell or method according to paragraph 6, wherein the magnesium-containing substrate comprises at least 90 at % of magnesium, and wherein the magnesium-containing substrate comprises a wire, a rod, a foil, a sheet, a plate, a film, a disk, a strip, a container, a conduit, a pipe, an end cap, a plug, or any combination thereof.

9. The solid state battery cell or method according to any one of paragraphs 1-8, wherein the magnesium compound comprises magnesium oxide, magnesium hydroxide, magnesium chloride, magnesium perchlorate, magnesium chlorite, magnesium hypochlorite, magnesium sulfate, magnesium sulfite, magnesium carbonate, magnesium cyanide, magnesium acetate, magnesium formate, magnesium hydrogen carbonate, magnesium nitride, magnesium nitrate, magnesium borate, magnesium aluminum sulfate, magnesium aluminum silicate, magnesium aluminum oxide, or any combination thereof.

10. The solid state battery cell or method according to any one of paragraphs 1-9, wherein the electrically conductive material in the counter electrode comprises graphite, a graphite compound, a graphite material, or any mixture thereof; or wherein the electrically conductive material in the counter electrode comprises graphite intercalated with zinc chloride, copper chloride, nickel chloride, manganese chloride, aluminum chloride, iron chloride, gallium chloride, zirconium chloride, or any mixture thereof; or wherein the counter electrode comprises graphite, a graphite compound, a graphite material, or any mixture thereof; or wherein the counter electrode comprises graphite intercalated with sodium, potassium, lithium, rubidium, magnesium, calcium, beryllium, erbium, ytterbium, an ion thereof, an alloy thereof, or any mixture thereof; or wherein the counter electrode comprises graphite intercalated with an ionic compound, wherein the ionic compound comprises a cation or an anion, wherein the cation comprises Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof, and wherein the anion comprises perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

11. The solid state battery cell or method according to any one of paragraphs 1-10, wherein the counter electrode comprises a composite material, wherein the composite material comprises the electrically conductive material and an ion conductive substance.

12. The solid state battery cell or method according to paragraph 11, wherein the ion conductive substance comprises a hydrated material.

13. The solid state battery cell or method according to paragraph 12, wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

14. The solid state battery cell or method according to paragraph 11, wherein the electrically conductive material comprises graphite and the ion conductive substance comprises magnesium oxide, magnesium peroxide, magnesium hydroxide, or any mixture thereof.

15. The solid state battery cell or method according to paragraph 14, wherein the graphite is in a form of flakes, powders, fibers, foams, or a layered film.

16. The solid state battery cell or method according to paragraph 14, wherein the graphite comprises a graphene compound, an element incorporated between graphene layers, a compound incorporated between graphene layers, or any mixture thereof; or wherein the graphite comprises graphene oxide, graphite doped with copper, graphite doped with silver, graphite doped with a salt, or any mixture thereof.

17. The solid state battery cell or method according to paragraph 14, wherein the composite material comprises multiple layers of different ratios of electrically conductive material to ion conductive material.

18. The solid state battery cell or method according to paragraph 11, wherein the ion conductive substance comprises a salt, wherein the salt comprises a cation or an anion, wherein the cation comprises aluminum, ammonium, calcium, cesium, copper, iron, magnesium, manganese, potassium, sodium, tin, zinc, or any mixture thereof, and wherein the anion comprises chloride, perchlorate, chlorite, hypochlorite, sulfate, sulfite, hydrogen sulfate, carbonate, hydrogen carbonate, cyanide, acetate, formate, acrylate, or any mixture thereof.

19. The solid state battery cell or method according to paragraph 11, wherein the ion conductive substance comprises a metal oxide and a salt, wherein the metal oxide comprises magnesium oxide, tin oxide, aluminum oxide, iron oxide, copper oxide, zinc oxide, vanadium oxide, cerium oxide, or any mixture thereof, wherein the salt comprises a cation or an anion, wherein the cation comprises aluminum, ammonium, calcium, cesium, copper, iron, magnesium, manganese, potassium, sodium, tin, zinc, or any mixture thereof, and wherein the anion comprises chloride, perchlorate, chlorite, hypochlorite, sulfate, sulfite, hydrogen sulfate, carbonate, hydrogen carbonate, cyanide, acetate, formate, acrylate, or any mixture thereof.

20. The solid state battery cell or method according to paragraph 11, wherein the ion conductive substance comprises a metal hydroxide and a salt, wherein the metal hydroxide comprises potassium hydroxide, sodium hydroxide, lithium hydroxide, cesium hydroxide, magnesium hydroxide, calcium hydroxide, aluminum hydroxide, or any mixture thereof, wherein the salt comprises a cation or an anion, wherein the cation comprises aluminum, ammonium, calcium, cesium, copper, iron, magnesium, manganese, potassium, sodium, tin, zinc, or any mixture thereof, and wherein the anion comprises chloride, perchlorate, chlorite, hypochlorite, sulfate, sulfite, hydrogen sulfate, carbonate, hydrogen carbonate, cyanide, acetate, formate, or any mixture thereof.

21. The solid state battery cell or method according to paragraph 11, wherein the ion conductive substance comprises a crystalline layered material comprising a plurality of monolayers disposed on one another.

22. The solid state battery cell or method according to paragraph 11, wherein the ion conductive substance comprises a mixture comprising a first substance and a second substance, and wherein an ion conductive path exists along an interface between the first substance and the second substance.

23. The solid state battery cell or method according to any one of paragraphs 1-22, wherein the solid state ion conductor comprises a first ion conductor and a second ion conductor, wherein the first ion conductor is disposed on the electrode and comprises the ion conductive material, and wherein the second ion conductor is disposed on the first ion conductor.

24. The solid state battery cell or method according to paragraph 23, wherein the first ion conductor or the second ion conductor comprises a hydrated material.

25. The solid state battery cell or method according to any one of paragraphs 1-24, wherein the ion conductive material comprises a hydrated material.

26. The solid state battery cell or method according to paragraph 25, wherein the hydrated material comprises a hydrate complex, and wherein the hydrate complex comprises one or more water molecules chemically bonded to a substance.

27. The solid state battery cell or method according to paragraph 26, wherein the hydrate complex comprises one or more water molecules chemically bonded to the surface of the substance or incorporated into a crystalline structure of the substance.

28. The solid state battery cell or method according to paragraph 26, wherein the substance is an element or a compound.

29. The solid state battery cell or method according to paragraph 25, wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

30. The solid state battery cell or method according to paragraph 25, wherein the hydrated material comprises magnesium sulfate hydrate, copper sulfate hydrate, potassium aluminum sulfate hydrate, cobalt chloride hydrate, magnesium acetate hydrate, vanadium oxide hydrate, iron oxide hydrate, sodium calcium aluminum magnesium silicate hydroxide hydrate, magnesium silicate hydrate, hydrated aluminum silicate, iron cyanide hydrate, magnesium borate hydrate, magnesium nitrate hydrate, hydrates thereof, isomers thereof, or any combination thereof.

31. The solid state battery cell or method according to paragraph 25, wherein the hydrated material comprises a mobile ion, wherein the mobile ion has a hydrated radius of about 0.05 nm to less than 0.5 nm.

32. The solid state battery cell or method according to any one of paragraphs 1-31, wherein the hydrated material provides the mobile ion as an electrical current flows through the solid state battery cell.

33. The solid state battery cell or method according to any one of paragraphs 1-32, wherein the mobile ion has a hydrated radius of about 0.1 nm to less than 0.5 nm.

34. The solid state battery cell or method according to any one of paragraphs 1-33, wherein the mobile ion has a hydrated radius of about 0.1 nm to less than 0.4 nm.

35. The solid state battery cell or method according to any one of paragraphs 1-34, wherein the mobile ion has a hydrated radius of about 0.3 nm to less than 0.5 nm.

36. The solid state battery cell or method according to paragraph 25, wherein the hydrated material comprises an ionic compound, wherein the ionic compound comprises a cation or an anion, wherein the cation comprises Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof, and wherein the anion comprises perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

37. The solid state battery cell or method according to any one of paragraphs 1-36, wherein the counter electrode and the solid state ion conductor have a combined thickness of about 2.5 μm to about 250 μm.

38. The solid state battery cell or method according to any one of paragraphs 1-37, wherein a surface of the counter electrode and a surface of the solid state ion conductor contact each other at an interface, wherein the surface of the counter electrode has a roughness of about 0.005 μm to about 500 μm, and wherein the surface of the solid state ion conductor has a roughness of about 0.01 μm to about 100 μm, as measured according to ASTM D7127-2013.

39. The solid state battery cell or method according to any one of paragraphs 1-38, wherein the ion conductive material has an ionic conductivity of greater than 1×10⁻⁸ S/cm, and wherein the ion conductive material has an electron conductivity of 1×10⁻⁸ S/cm or less.

40. The solid state battery cell or method according to any one of paragraphs 1-39, wherein the electrode comprises at least 95 at % of magnesium.

41. The solid state battery cell or method according to any one of paragraphs 1-40, wherein the electrode comprises at least 99 at % of magnesium.

42. The solid state battery cell or method according to any one of paragraphs 1-41, wherein the electrode comprises at least 99.9 at % of magnesium.

43. The solid state battery cell or method according to any one of paragraphs 1-42, wherein the electrode comprises at least 99.95 at % of magnesium.

44. The solid state battery cell or method according to any one of paragraphs 1-43, wherein the electrode comprises about 1 at % to about 7 at % of aluminum.

45. The solid state battery cell or method according to any one of paragraphs 1-44, wherein the electrode comprises about 2 at % to about 5 at % of aluminum.

46. The solid state battery cell or method according to any one of paragraphs 1-45, wherein the electrode comprises about 3 at % to about 4 at % of aluminum.

47. The solid state battery cell or method according to any one of paragraphs 1-46, wherein the electrically conductive material in the counter electrode comprises graphite, silver, nickel, gold, copper, a conductive polymer, or any combination thereof.

48. The solid state battery cell or method according to any one of paragraphs 1-47, wherein the electrically conductive material in the counter electrode comprises graphite, and wherein the graphite is in a form of flakes, powders, fibers, foams, or a layered film.

49. The solid state battery cell or method according to any one of paragraphs 1-48, wherein the electrically conductive material in the counter electrode comprises graphite, and wherein the graphite comprises a graphene compound, an element incorporated between graphene layers, a compound incorporated between graphene layers, or any mixture thereof.

50. The solid state battery cell or method according to any one of paragraphs 1-49, wherein the electrically conductive material in the counter electrode comprises graphene oxide, graphite doped with copper, graphite doped with silver, graphite doped with a salt, or any mixture thereof.

51. The solid state battery cell or method according to any one of paragraphs 1-50, wherein the electrically conductive material in the counter electrode comprises a metal, wherein the metal comprises silver, nickel, gold, copper, alloys thereof, or any mixture thereof, and wherein the metal is in a form of particles or a film.

52. The solid state battery cell or method according to any one of paragraphs 1-51, wherein the electrically conductive material in the counter electrode comprises a conductive polymer, and wherein the conductive polymer comprises a poly(3,4-ethylenedioxythiophene) polystyrene sulfonate (PEDOT:PSS), a polyaniline (PANI), a polythiophene (PT), a polypyrrole (PPy), copolymers thereof, or any mixture thereof.

53. The solid state battery cell or method according to any one of paragraphs 1-52, further comprising a current collector electrically coupled to the counter electrode.

54. The solid state battery cell or method according to any one of paragraphs 1-53, wherein the current collector comprises aluminum, copper, silver, gold, aluminum, nickel, iron, chromium, steel, stainless steel, brass, bronze, alloys thereof, or any combination thereof.

55. The solid state battery cell or method according to any one of paragraphs 1-54, wherein the current collector comprises a conductive mesh, a conductive tape, a conductive fabric, a conductive paper, or any combination thereof.

56. The solid state battery cell or method according to any one of paragraphs 1-55, wherein the current collector comprises a copper-containing mesh, a brass-containing mesh, a steel-containing mesh, a copper-containing tape, an aluminum-containing tape, a metal-coated polyester conductive fabric comprising copper or nickel, a conductive carbon paper, or any combination thereof.

57. The solid state battery cell or method according to any one of paragraphs 1-56, wherein the current collector is adhered to the counter electrode via a conductive adhesive disposed at least partially between the current collector and the counter electrode.

58. The solid state battery cell or method according to any one of paragraphs 1-57, wherein the current collector is adhered to the counter electrode by an adhesion force derived from compressing or pressing the current collector and the counter electrode together.

59. The solid state battery cell or method according to any one of paragraphs 1-58, further comprising an enclosure at least partially surrounding the electrode, the counter electrode, and the solid state ion conductor.

60. The solid state battery cell or method according to paragraph 59, wherein the enclosure comprises a heat shrink tubing, a heat shrink wrap, a thermal laminating foil, a pressure laminating foil, a wrapping fabric comprising a liquid-proofing material, a wrapping paper comprising a liquid-proofing material, or any combination thereof.

61. The solid state battery cell or method according to any one of paragraphs 1-60, wherein the solid state battery cell has a thickness of about 0.01 mm to less than 1 mm and a length by width surface area of about 0.1 cm² to less than 5 cm².

62. The solid state battery cell or method according to any one of paragraphs 1-61, wherein the solid state battery cell has a thickness of about 0.01 mm to less than 0.5 mm and a length by width surface area of about 0.1 cm² to less than 1 cm².

63. The solid state battery cell or method according to any one of paragraphs 1-62, wherein the solid state battery cell produce a voltage of about 0.5 V to about 3.2 V.

64. The solid state battery cell or method according to any one of paragraphs 1-63, wherein the solid state battery cell produce a voltage of about 0.8 V to about 2.7 V.

65. The solid state battery cell or method according to any one of paragraphs 1-64, wherein the solid state battery cell produce a voltage of about 1 V to about 2.2 V.

66. The solid state battery cell or method according to any one of paragraphs 1-65, wherein the solid state battery cell produce a voltage of greater than 1 V to less than 2.2 V.

67. The solid state battery cell or method according to any one of paragraphs 1-66, wherein the solid state battery cell produce a voltage of about 1.2 V to about 2.2 V.

68. The solid state battery cell or method according to any one of paragraphs 1-67, wherein the solid state battery cell produce a voltage of about 1.4 V to about 1.9 V.

69. The method according to paragraph 4 or 5, further comprising flowing an electrical current through the reagent solution and into the magnesium-containing substrate when reacting the portion of the magnesium-containing substrate and the reagent solution to produce the ion conductive material, wherein the reagent solution comprises an electrolyte.

70. The method according to paragraph 69, wherein the electrical current is a direct current and has a voltage of about 1 V to about 5 V, and wherein the electrical current flows through the reagent solution and the magnesium-containing substrate for a period of about 5 seconds to about 5 minutes.

71. The method according to paragraph 70, wherein the electrical current flows through the reagent solution and the magnesium-containing substrate for a period of about 10 seconds to about 2 minutes.

72. The method according to paragraph 4 or 5, further comprising: combining graphite and a substance to produce a mixture comprising the graphite and the substance; and applying the mixture comprising the graphite and the substance over at least a portion of the solid state ion conductor to form the counter electrode.

73. The method according to paragraph 72, further comprising heating the mixture comprising the graphite and the substance to a temperature of greater than 60° C. to less than 400° C. to form the counter electrode.

74. The method according to paragraph 72, wherein the substance comprises an adhesive.

75. The method according to paragraph 74, wherein the adhesive comprises a polymeric material, and wherein the polymeric material comprises a poly(acrylic acid), a polyacrylate, a poly(methyl acrylate), a poly(vinyl acetate), an alkyl derivative thereof, a copolymer thereof, a salt thereof, or any mixture thereof.

76. The method according to paragraph 74, wherein the adhesive comprises a plurality of particles and a solvent, wherein the plurality of particles comprises the polymeric material and have an average particle size of less than 1 μm.

77. The method according to paragraph 4 or 5, further comprising: combining graphite and an adhesive to produce a mixture comprising the graphite and the adhesive; and applying the mixture comprising the graphite and the adhesive over at least a portion of the solid state ion conductor to form the counter electrode.

78. The method according to paragraph 4 or 5, further comprising forming a mask on at least a portion of the unreacted portion of the magnesium-containing substrate prior to combining the magnesium-containing substrate and the reagent solution.

79. The method according to paragraph 4 or 5, wherein the reagent solution comprises copper oxide, iron oxide, manganese oxide, tin oxide, vanadium oxide, cerium oxide, ammonium perchlorate, potassium perchlorate, sodium perchlorate, ammonium chloride, aluminum chloride, calcium chloride, cesium chloride, magnesium chloride, potassium chloride, sodium chloride, magnesium sulfate, copper sulfate, aluminum silicate, potassium aluminum silicate, cobalt chloride, magnesium acetate, iron cyanide, magnesium hydroxide, calcium hydroxide, sodium hydroxide, lithium hydroxide, cesium hydroxide, aluminum hydroxide, ammonium hydroxide, sodium calcium aluminum magnesium silicate hydroxide, hydrogen chloride, hydrogen sulfate, hydrogen phosphate, hydrates thereof, isomers thereof, or any combination thereof.

80. The method according to paragraph 4 or 5, further comprising forming a layer comprising a hydrated material on the solid state ion conductor prior to forming the counter electrode, wherein the layer comprising the hydrated material is disposed at least partially between the solid state ion conductor and the counter electrode.

81. The method according to paragraph 80, wherein the hydrated material comprises a hydrate complex, and wherein the hydrate complex comprises one or more water molecules chemically bonded to a substance.

82. The method according to paragraph 4 or 5, wherein the electrode comprises at least 90 at % of magnesium, and wherein the ion conductive material comprises a magnesium compound.

83. The method according to paragraph 4 or 5, wherein the magnesium-containing substrate comprises a wire, a rod, a foil, a sheet, a plate, a film, a disk, a strip, a container, a conduit, a pipe, an end cap, a plug, or any combination thereof.

84. A printed circuit board (PCB) comprising the solid state battery cell or method according to any one of paragraphs 1-83.

85. A coil battery comprising a core and the solid state battery cell or method according to any one of paragraphs 1-84, wherein the core is electrically conductive, wherein the solid state battery cell has an aspect ratio of greater than 10, wherein the solid state battery cell is wrapped around the core forming a plurality of coils, and wherein the plurality of coils has at least 3 coils to about 100 coils.

86. A container battery comprising the solid state battery cell or method according to any one of paragraphs 1-85, comprising a cavity at least partially defined by the electrode or the counter electrode.

87. The container battery of paragraph 86, further comprising a substance disposed in the cavity, wherein the substance comprises a pharmaceutically active substance, a medicinal composition, a nutraceutical composition, a food, a dye, a perfume, a cosmetic composition, a detergent, a herbicide, a pesticide, a propellant, an explosive, or any mixture thereof.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. And if applicable, all patents, test procedures, and other documents cited in this application are fully incorporated by reference to the extent such disclosure is not inconsistent with this application and for all jurisdictions in which such incorporation is permitted.

While the foregoing is directed to certain illustrative embodiments, other and further embodiments of the invention can be devised without departing from the basic scope thereof, and the scope thereof is determined by the claims that follow.

What is claimed is:

1. A solid state battery cell comprising a solid state ion conductor at least partially disposed between an electrode and a counter electrode, wherein:
the electrode comprises at least 90 at % of magnesium,
the counter electrode comprises an electrically conductive material,
the solid state ion conductor comprises an ion conductive material,
the ion conductive material comprises a magnesium compound, and
the counter electrode and the solid state ion conductor have a combined thickness of about 1 μm to less than 1 mm.

2. The solid state battery cell of claim 1, wherein the electrode and at least a portion of the solid state ion conductor are derived from the same magnesium-containing substrate.

3. The solid state battery cell of claim 2, wherein the magnesium compound in the solid state ion conductor is produced from a first portion of the magnesium-containing substrate and the magnesium in the electrode is from a second portion of the magnesium-containing substrate.

4. The solid state battery cell of claim 1, wherein the counter electrode comprises a composite material, and wherein the composite material comprises the electrically conductive material and an ion conductive substance.

5. The solid state battery cell of claim 4, wherein the electrically conductive material comprises graphite and the ion conductive substance comprises magnesium oxide, magnesium peroxide, magnesium hydroxide, or any mixture thereof.

6. The solid state battery cell of claim 4, wherein the ion conductive substance comprises a hydrated material.

7. The solid state battery cell of claim 6, wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

8. The solid state battery cell of claim 1, wherein the counter electrode comprises graphite, a graphite compound, a graphite material, or any mixture thereof.

9. The solid state battery cell of claim 1, wherein the counter electrode comprises graphite intercalated with sodium, potassium, lithium, rubidium, magnesium, calcium, beryllium, erbium, ytterbium, an ion thereof, an alloy thereof, or any mixture thereof.

10. The solid state battery cell of claim 1, wherein the counter electrode comprises graphite intercalated with an ionic compound, wherein the ionic compound comprises a cation or an anion, wherein the cation comprises Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof, and wherein the anion comprises perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

11. The solid state battery cell of claim 1, wherein the ion conductive material comprises a hydrated material.

12. The solid state battery cell of claim 11, wherein the hydrated material comprises a hydrate complex, and wherein the hydrate complex comprises one or more water molecules chemically bonded to a substance.

13. The solid state battery cell of claim 11, wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

14. The solid state battery cell of claim 11, wherein the hydrated material comprises a mobile ion, wherein the mobile ion has a hydrated radius of about 0.05 nm to less than 0.5 nm.

15. The solid state battery cell of claim 11, wherein the hydrated material comprises an ionic compound, wherein the ionic compound comprises a cation and an anion, wherein the cation comprises Cu⁺, Cu²⁺, Fe²⁺, Fe³⁺, Zn²⁺, Sn²⁺, Sn⁴⁺, Al³⁺, Mn²⁺, Mn⁴⁺, Ti³⁺, Ti⁴⁺, Na⁺, K⁺, Cs⁺, Mg²⁺, Ca²⁺, V²⁺, V⁴⁺, V⁵⁺, Be²⁺, Ce⁴⁺, or any mixture thereof, and wherein the anion comprises perchlorate, chlorate, chlorite, hydrogen sulfate, carbonate, nitrate, nitrite, phosphate, oxide, aluminate, orthosilicate, silicate, aluminum silicate, permanganate, hydroxide, acetate, formate, or any mixture thereof.

16. The solid state battery cell of claim 1, wherein the electrode comprises about 1 at % to about 7 at % of aluminum.

17. The solid state battery cell of claim 1, wherein the electrically conductive material in the counter electrode comprises graphite, silver, nickel, gold, copper, a conductive polymer, or any combination thereof.

18. A solid state battery cell comprising a solid state ion conductor disposed between an electrode and a counter electrode, wherein:
the electrode comprises at least 90 at % of magnesium,
the counter electrode comprises an electrically conductive material and an ion conductive substance,
the solid state ion conductor comprises an ion conductive material,
the ion conductive material comprises a hydrated material, and
the counter electrode and the solid state ion conductor have a combined thickness of about 1 μm to less than 1 mm.

19. The solid state battery cell of claim 18, wherein each of the ion conductive substance and the ion conductive material independently comprises a hydrated material, and wherein the hydrated material comprises a hydrated sulfate, a hydrated chloride, a hydrated cyanide, a hydrated silicate, a hydrated aluminate, a hydrated acetate, a hydrated oxide, a hydrated hydroxide, hydrated graphite, or any mixture thereof.

20. A method for making a solid state battery cell, comprising:
combining a magnesium-containing substrate comprising at least 90 at % of magnesium and a reagent solution to produce a mixture;
reacting a portion of the magnesium-containing substrate and the reagent solution in the mixture to produce a solid state ion conductor disposed on an electrode, wherein the solid state ion conductor comprises an ion conductive material derived from the reacted portion of the magnesium-containing substrate and the reagent solution and the electrode comprises an unreacted portion of the magnesium-containing substrate; and
forming a counter electrode comprising an electrically conductive material over the solid state ion conductor, wherein the solid state ion conductor is at least partially disposed at least partially between the electrode and the counter electrode, and wherein the counter electrode and the solid state ion conductor have a combined thickness of about 1 μm to less than 1 mm.
